(19) United States
(12) Patent Application Publication
(10) Pub. No.: US 2011/0255631 A1
(43) Pub. Date: Oct. 20, 2011

(54) METHODS AND APPARATUS FOR FAST SYNCHRONIZATION USING TAIL BITING CONVOLUTIONAL CODES

(75) Inventor: Zhouyue Pi, Allen, TX (US)

(73) Assignee: Samsung Electronics Co., Ltd., Suwon-si (KR)

(21) Appl. No.: 13/081,355

(22) Filed: Apr. 6, 2011

Related U.S. Application Data
(60) Provisional application No. 61/326,107, filed on Apr. 20, 2010.
(60) Provisional application No. 61/434,687, filed on Jan. 20, 2011.

(51) Int. Cl. H04L 27/00

(52) U.S. Cl. 375/295; 375/340

(57) ABSTRACT

For use in a wireless communication network, a transmitter is configured to encode a message field in a control channel message by cyclically shifting the control channel message according to the value of the message field. The transmitter includes a CRC (cyclic redundancy check) encoder configured to encode the control channel message using a cyclic redundancy check. The transmitter may also includes a CIF (carrier indication field) encoder configured to encode a carrier indication value in the control channel message by cyclically shifting the control channel message according to the carrier indication value configured to indicate an intended component carrier of the control channel message. Alternatively, the transmitter may also include a frame timing encoder configured to encode frame timing in the control channel message by cyclically shifting the control channel message according to the frame timing.

### CROSS-REFERENCE TO RELATED APPLICATION(S) AND CLAIM OF PRIORITY

The present application is related to U.S. Provisional Patent Application No. 61/326,107, filed Apr. 20, 2010, entitled “METHODS AND APPARATUS TO ENCODE AND DECODE CARRIER INDICATION FIELD IN A CONTROL CHANNEL MESSAGE IN A MULTI-CARRIER COMMUNICATION SYSTEM”. Provisional Patent Application No. 61/326,107 is assigned to the assignee of the present application and is hereby incorporated by reference into the present application as if fully set forth herein. The present application hereby claims priority under 35 U.S.C. §119(e) to U.S. Provisional Patent Application No. 61/326,107.

The present application is also related to U.S. Provisional Patent Application No. 61/434,687, filed Jan. 20, 2011, entitled “METHODS AND APPARATUS FOR FAST SYNCHRONIZATION USING TAIL BITING CONVOLUTIONAL CODES”. Provisional Patent Application No. 61/434,687 is assigned to the assignee of the present application and is hereby incorporated by reference into the present application as if fully set forth herein. The present application hereby claims priority under 35 U.S.C. §119(e) to U.S. Provisional Patent Application No. 61/434,687.

### TECHNICAL FIELD OF THE INVENTION

The present application relates generally to wireless communication and, more specifically, to uses of tail-biting convolutional coding to encode control messages in wireless communication.

### BACKGROUND OF THE INVENTION

3 GPP Long Term Evolution (LTE) is a recent standard in mobile communication technology. 3 GPP LTE is a project of the 3rd Generation Partnership Project (3 GPP). In 3 GPP LTE systems, the physical downlink control channel (PDCCH) carries scheduling assignments and other control information. A PDCCH message may be encoded by a cyclic redundancy check (CRC) for error detection purposes. The CRC field is scrambled by an identifier of the intended user equipments (UEs). This UE identifier is also known as the Radio Network Temporary Identifier (RNTI) in 3 GPP LTE systems. There are different kinds of RNTIs in the 3 GPP LTE and LTE-A systems, e.g., cell RNTI (C-RNTI), random access RNTI (RA-RNTI), etc.

Time synchronization is one of the first steps in establishing communication between two devices. Existing wireless communication systems, including WiFi, CDMA/CDMA2000/1xEV-DO, GSM/WCDMA/HSPA, mobile WiMAX, and LTE/LTE-Advanced systems, all have carefully designed time synchronization signals and procedures.

A convolutional code is a type of error-correcting code in which each m-bit information symbol to be encoded is transformed into an n-bit symbol, where m/n is the code rate (n≧M).

### SUMMARY OF THE INVENTION

For use in a multi-carrier wireless communication network, a transmitter configured to encode a control channel message is provided. The transmitter includes a CRC (cyclic redundancy check) encoder configured to encode the control channel message using a cyclic redundancy check. The transmitter also includes a CIF (carrier indication field) encoder coupled to the CRC encoder and configured to encode a carrier indication value in the control channel message, the carrier indication value configured to indicate an intended component carrier of the control channel message.

For use in a multi-carrier wireless communication network, a method for a transmitter to encode a control channel message is provided. The method includes encoding the control channel message using a cyclic redundancy check (CRC). The method also includes encoding a carrier indication value in the control channel message, the carrier indication value configured to indicate an intended component carrier of the control channel message.

For use in a wireless network, a transmitter configured to encode timing synchronization information is provided. The transmitter includes a CRC (cyclic redundancy check) encoder configured to encode a physical broadcast channel (PBCH) message using a cyclic redundancy check. The transmitter also includes a cyclic shift block configured to encode frame timing information in the PBCH message. The transmitter further includes a tail-biting convolutional code (TBCC) encoder configured to encode the PBCH message using a TBCC code.

For use in a wireless network, a method of timing synchronization at a transmitter is provided. The method includes encoding a physical broadcast channel (PBCH) message using a cyclic redundancy check (CRC). The method also includes encoding frame timing information in the PBCH message, and encoding the PBCH message using a tail-biting convolutional code (TBCC).

For use in a wireless communication network, a method for a receiver to detect frame timing is provided. The method includes receiving code symbols of a physical broadcast channel (PBCH) in a message. The method also includes decoding the received code symbols using a tail biting convolutional code (TBCC). The method further includes examining the TBCC-decoded symbols for a cyclic redundancy check (CRC). The method still further includes cyclically shifting the TBCC-decoded symbols. The method also includes repeating the examining and cyclically shifting steps until a CRC check is established. The method further includes determining a current frame number based on a number of times the TBCC-decoded symbols are cyclically shifted.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a rate 1/2 convolutional code with a constraint length of three;

FIG. 2 illustrates a trellis representation of a convolutional code;

FIG. 3 illustrates a trellis representation of a tail-biting convolutional code (TBCC);

FIG. 4 illustrates another trellis representation of a tail-biting convolutional code (TBCC);

FIG. 5 illustrates a tail-biting convolutional code that may serve as a forward-error-correction (FEC) code for a physical downlink control channel (PDCCH) or physical broadcast channel (PBCH) in LTE, according to embodiments of the present disclosure;

FIG. 6 illustrates a transmitter configured to perform an encoding process of a PDCCH, according to one embodiment of the present disclosure;

FIG. 7 illustrates the use of a circular buffer rate matcher, according to one embodiment of the present disclosure;

FIG. 8 illustrates a transmitter and a receiver configured to process multiple PDCCHs according to one embodiment of the present disclosure;

FIG. 9 illustrates how multiple PDCCHs are multiplexed and mapped to time-frequency resources in LTE and LTE-A, according to one embodiment of the present disclosure;

FIG. 10 illustrates a control channel element (CCE) aggregation in LTE and LTE-A according to one embodiment of the present disclosure;

FIG. 11 illustrates a transmitter configured to perform a carrier indication field (CIF) encoding process, according to one embodiment of the present disclosure;

FIG. 12 illustrates a transmitter configured to perform a different CIF encoding process, according to one embodiment of the present disclosure;

FIG. 13 illustrates a transmitter configured to perform CIF encoding using interleaving, according to one embodiment of the present disclosure;

FIG. 14 illustrates a transmitter configured to perform cyclic redundancy check (CRC) encoding depending on the CIF value, according to one embodiment of the present disclosure;

FIG. 15 illustrates a transmitter that uses different PDCCH scrambling depending on the component carrier the PDCCH message is intended for, according to one embodiment of the present disclosure;

FIG. 16 illustrates a transmitter that changes resource mapping depending on the intended carrier, according to one embodiment of the present disclosure;

FIG. 17 illustrates a transmitter that changes rate matching depending on the intended carrier, according to one embodiment of the present disclosure;

FIG. 18 illustrates synchronization signals in an LTE system;

FIG. 19 illustrates a PBCH in LTE systems;

FIG. 20 illustrates a PBCH transmitter and receiver for use in an LTE system;

FIG. 21 illustrates encoding of frame timing information using a cyclic shift with TBCC, according to one embodiment of the present disclosure;

FIG. 22 illustrates encoding frame timing information using a cyclic shift after TBCC encoding, according to an embodiment of the present disclosure;

FIG. 23 illustrates an example of this encoding and decoding arrangement, according to an embodiment of the present disclosure;

FIG. 24 illustrates soft combining of multiple TBCC-encoded PBCH transmissions with different cyclic shifts, according to one embodiment of the present disclosure; and

FIG. 25 illustrates a method for a receiver to detect frame timing, according to one embodiment of the present disclosure.

### DETAILED DESCRIPTION OF THE INVENTION

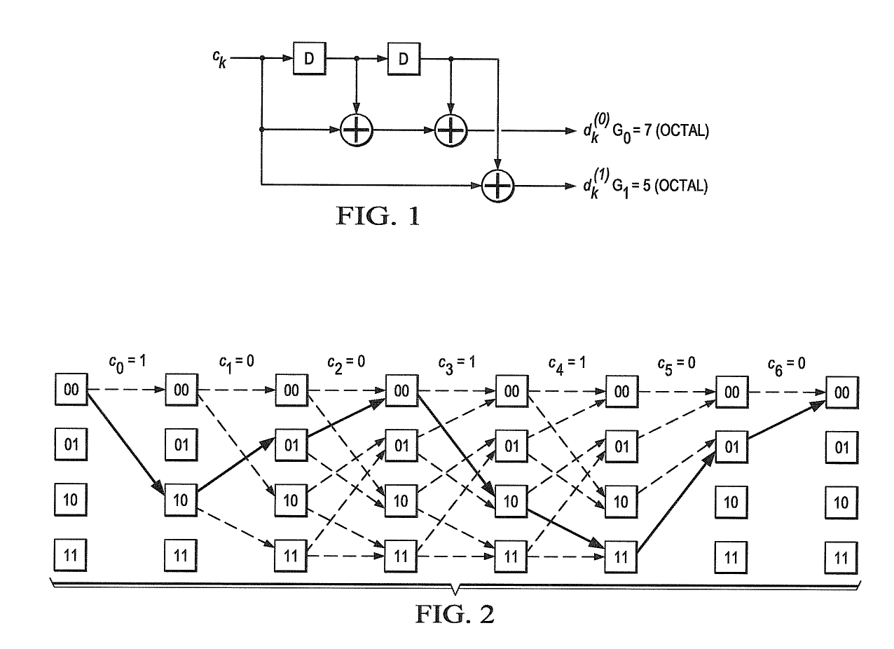

FIGS. 1 through 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:

3 GPP Technical Report No. 21.905, “Vocabulary for 3 GPP Specifications”;

3 GPP Technical Specification No. 36.201, “Evolved Universal Terrestrial Radio Access (E-UTRA); Physical Layer—General Description”;

3 GPP Technical Specification No. 36.211, “Evolved Universal Terrestrial Radio Access (E-UTRA); Physical channels and modulation”;

3 GPP Technical Specification No. 36.212, “Evolved Universal Terrestrial Radio Access (E-UTRA); Multiplexing and channel coding”;

3 GPP Technical Specification No. 36.213, “Evolved Universal Terrestrial Radio Access (E-UTRA); Physical layer procedures”;

3 GPP Technical Specification No. 36.214, “Evolved Universal Terrestrial Radio Access (E-UTRA); Physical layer—Measurements”;

3 GPP Technical Specification No. 36.104, “Evolved Universal Terrestrial Radio Access (E-UTRA); Base Station (BS) radio transmission and reception”;

3 GPP Technical Specification No. 36.101, “Evolved Universal Terrestrial Radio Access (E-UTRA); User Equipment (UE) radio transmission and reception”;

3 GPP Technical Specification No. 36.321, “Evolved Universal Terrestrial Radio Access (E-UTRA); Medium Access Control (MAC) protocol specification”;

3 GPP Technical Report No. 36.814, “Further Advancements for E-UTRA; Physical Layer Aspects”; and

3 GPP Technical Report No. 36.912, “Feasibility Study for Further Advancement for E-UTRA (LTE-Advanced)”.

Convolutional codes are used extensively in wireless communication applications in order to achieve reliable data transfer. FIG. 1 illustrates an example of rate ½ convolutional code with a constraint length of three (3). As shown in FIG. 1, an encoder includes one input stream of payload bits and two output streams of coded bits. The input stream of payload bits to be encoded is shown as cₖ and the two output streams of coded bits are shown as dₖ⁽⁰⁾ and dₖ⁽¹⁾. As the input payload stream passes through one or more shift registers (indicated in FIG. 1 by the letter ‘D’), the two output streams of coded bits are obtained by linear operation (e.g., XOR operation) on the registers.

A convolution code can also be represented by a trellis. FIG. 2 illustrates one example of a trellis representation of a convolutional code. As the input stream of payload bits passes through the shift register, at each stage, the shift register shifts by one bit, and a new payload bit enters the shift register. As a result, the state of the shift register changes depending on the current input bit and the previous state of the shift register. Similarly, the output streams of coded bits are also driven by the current input bit and the previous state of the shift register. A convolutional code can be thus represented by a multi-stage trellis, such as shown in FIG. 2.

The bold line in FIG. 2 indicates a path on the trellis corresponding to a valid codeword of the convolutional code obtained by encoding a stream of payload bits c₀=1, c₁=0, c₂=0, c₃=1, c₄=1, c₅=0, c₆=0, using the convolutional code encoder shown in FIG. 1. In the trellis shown in FIG. 2, the encoder is initialized to all-zero state and is terminated at all-zero state. The knowledge of the initial state and end state of a trellis can facilitate the receiver to successfully decode the message. However, because the payload bits are often random, it is difficult to guarantee the end state to be all-zero even if the initial state is all-zero.

To solve this problem, one or more extra bits are often used to force the trellis to reach all-zero state. This process is also referred to as trellis termination. The bits that are used to terminate the trellis are referred to as tail bits. Trellis termination requires extra bits and increases overhead. In the example shown in FIG. 2, the last two bits of the seven-bit input stream are chosen to be ‘0 ’ to ensure that the trellis terminates after the last bit enters the shift register. That leaves five (5) bits for the actual message.

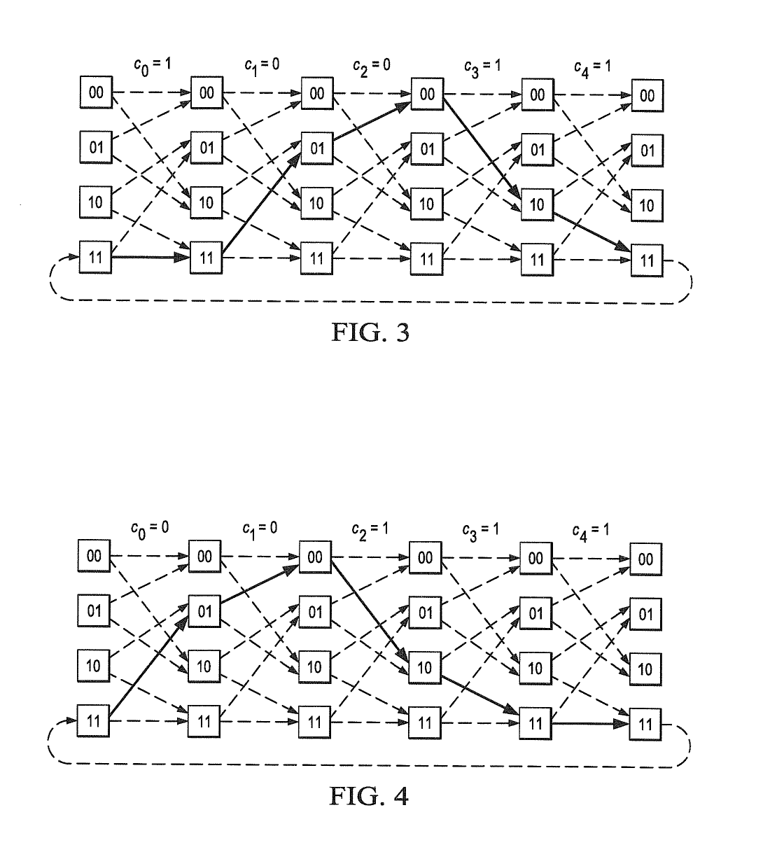

In some embodiments, the encoder may also be initialized by the last one or more bits of the input stream of payload bits. FIG. 3 illustrates one example. To encode a five-bit input stream using the convolutional encoder shown in FIG. 1, the shift register may be initialized by the last two bits of the input stream, i.e., c₃ and c₄. As the encoding process reaches the end, the state of the shift register will also be set by the last two bits of the input stream. Therefore, the trellis will terminate at the same state as the initial state. This kind of convolutional code is called a tail-biting convolutional code (TBCC). Compared with the convolutional codes that both starts and terminates at an all-zero state, TBCC does not need extra tail bits, thus reducing the overhead.

A cyclically shifted version of a TBCC codeword is still a valid TBCC codeword. For example, the TBCC codeword in FIG. 4 is obtained by cyclically shift the TBCC codeword shown in FIG. 3 by one stage along the trellis. Note that in order to create a cyclic shift of a TBCC codeword along the trellis, a system may either cyclically shift the output of the TBCC encoding along the trellis, or equivalently, the system may cyclically shift the message itself before the TBCC encoding.

In accordance with exemplary embodiments of the present disclosure, tail biting convolutional codes may be used to encode and decode a carrier indication field in a control channel message. TBCC may also be used to encode and decode a physical broadcast channel (PBCH) for fast synchronization between two devices.

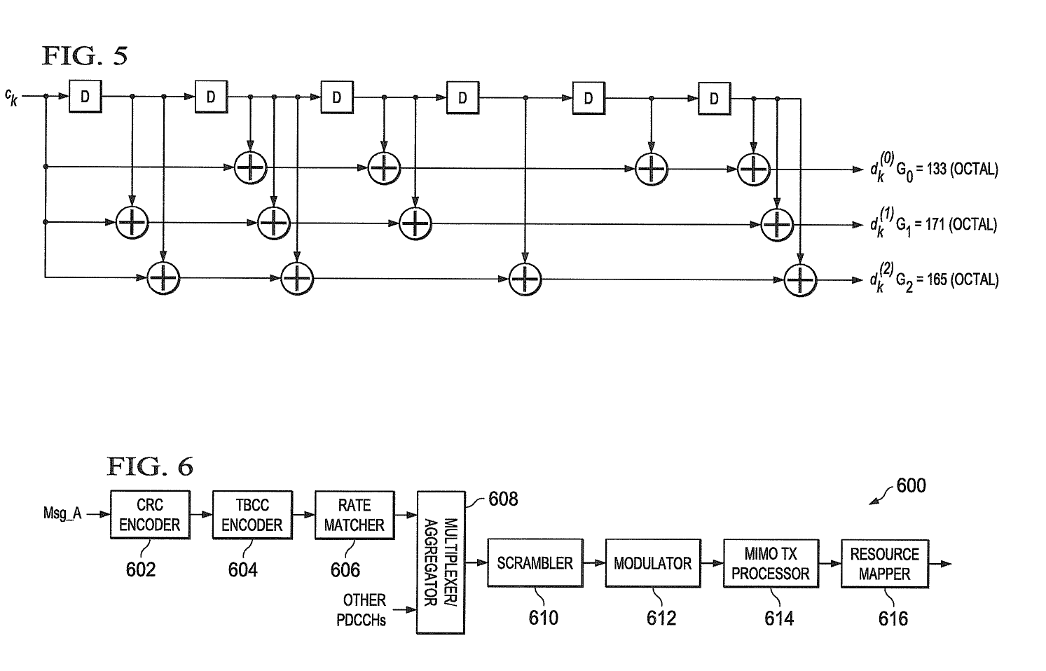

FIG. 5 illustrates a tail-biting convolutional code with a constraint length of seven (7) and a coding rate of ⅓ that may serve as the forward-error-correction (FEC) code for a PDCCH or PBCH in LTE, according to embodiments of the present disclosure. In order to achieve the same initial state as the final state (i.e., tail-biting), the shift register is initialized by the last six (6) information bits of the input bit stream. For a message c₀, c₁, c₂, c₃, . . . , c_{K-1}, assuming a TBCC as shown in FIG. 5 is used, there will be 3 branches of output as shown in the figure. The first branch is denoted as d₀⁽⁰⁾, d₁⁽⁰⁾, d₂⁽⁰⁾, d₃⁽⁰⁾, . . . , d_{K-1} the second branch as d₀⁽¹⁾, d₁⁽¹⁾, d₂⁽¹⁾, d₃⁽¹⁾, . . . , d_{K-1}⁽¹⁾, and the third branch as d₀⁽²⁾, d₁⁽²⁾, d₂⁽²⁾, d₃⁽²⁾, . . . , d_{K-1}⁽²⁾.

If the message is cyclically shifted to the left by one (1) bit, the input message to the TBCC encoder becomes c₁, c₂, c₃, . . . , c_{K-1}, c₀. Accordingly, the first output branch of the TBCC encoder becomes d₁⁽⁰⁾, d₂⁽⁰⁾, d₃⁽⁰⁾, . . . , d_{K-1}⁽⁰⁾, d₀⁽⁰⁾, the second output branch of the TBCC encoder becomes d₁⁽¹⁾, d₂⁽¹⁾, d₃⁽¹⁾, . . . , d_{K-1}⁽¹⁾, d₀⁽¹⁾, and the third output branch of the TBCC encoder becomes d₁⁽²⁾, d₂⁽²⁾, d₃⁽²⁾, . . . , d_{K-1}⁽²⁾, d₀⁽²⁾.

To achieve a cyclic shift along the trellis for a TBCC codeword, it is possible to either cyclically shift the input message, or cyclically shift the output branches of the TBCC encoder. Both operations are equivalent. In accordance with this disclosure, for the purpose of illustration, we may use either the cyclic shift of the message or the cyclic shift of the output branches to describe the embodiments. However, it will be understood that variations of the disclosed embodiments may be realized by exchanging the cyclic shift operation on the message with the cyclic shift of the output branches of the TBCC encoder.

In 3 GPP LTE systems, the physical downlink control channel (PDCCH) carries scheduling assignments and other control information. In an LTE or LTE-Advanced (LTE-A) system, a PDCCH message may be encoded by a CRC for error detection purposes.

FIG. 6 illustrates a transmitter configured to perform an encoding process of a PDCCH, according to one embodiment of the present disclosure. As shown in FIG. 6, a PDCCH message (indicated as ‘Msg_A’ in FIG. 6) is input into a CRC encoder 602 of transmitter 600. A CRC field is scrambled by the identifier of the intended user equipments (UEs). The UE identifier is also known as the Radio Network Temporary Identifier (RNTI) in 3 GPP LTE systems. There are different kinds of RNTIs in the 3 GPP LTE and LTE-A system, e.g., cell RNTI (C-RNTI), random access RNTI (RA-RNTI), etc. The purpose of scrambling the CRC field by the UE RNTI is to only allow the intended UE (or UEs) to correctly detect the message while the message appears to be an erroneous message to other unintended UEs.

The CRC encoded message that is output from the CRC encoder 602 is then encoded at a TBCC encoder 604 using a ⅓ rate TBCC.

A rate matcher 606 selects a number of coded bits from all the coded bits for the message generated by the TBCC encoder 604. A purpose of the rate matcher 606 is to match the number of transmitted coded bits of a PDCCH with the amount of resources allocated for transmission of that PDCCH. Multiple PDCCHs may be transmitted in one transmission time interval (TTI), and the multiple PDCCHs may be intended for one or multiple UEs. In LTE/LTE-A, one TTI is one subframe, which has a time span of 1 ms. The coded bits from multiple PDCCHs are multiplexed together at a multiplexer/aggregator 608, scrambled by a cell-specific scrambling sequence 610, and then modulated by a QPSK modulator 612.

MIMO processing (indicated at MIMO TX processor 614) may be applied to these modulation symbols if multiple antenna systems are deployed. For example, in LTE systems, SFBC or SFBC-FSTD scheme can be applied to PDCCH modulation symbols for a base station with two (2) transmit antennas or four (4) transmit antennas, respectively. After MIMO processing, a stream of modulation symbols are generated for each transmit antenna (or antenna port as defined in LTE systems). Upon further interleaving, the modulation symbols are mapped (using resource mapper 616) to resource elements (REs) on the time-frequency grid of a subframe that comprises of multiple OFDM symbols.

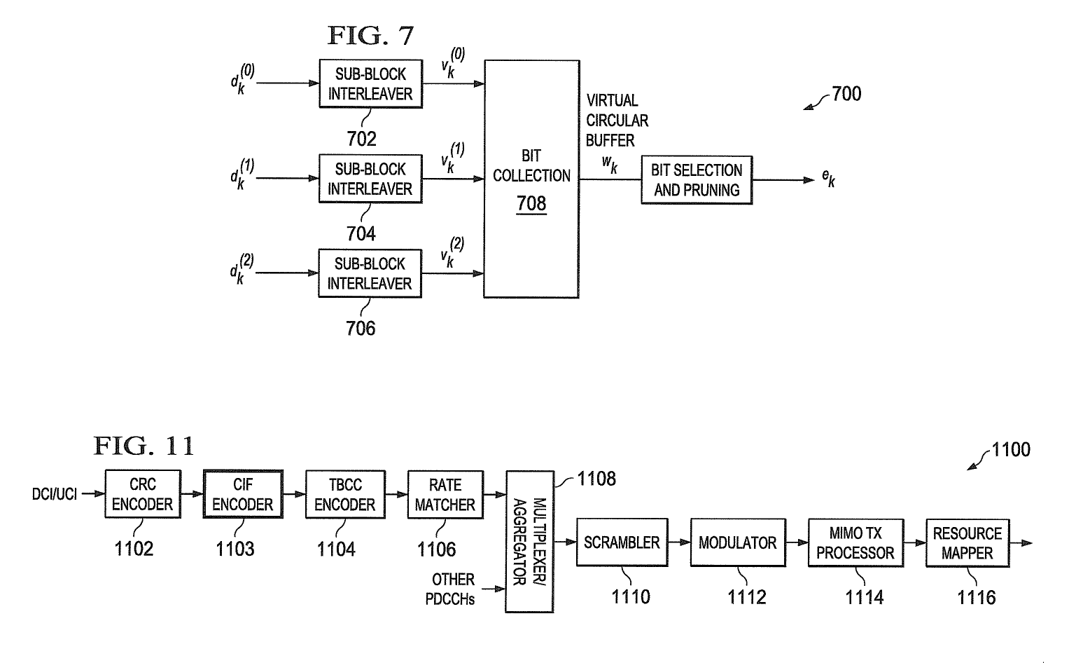

In certain embodiments, rate matching may be applied to the TBCC encoder output bit stream of a PDCCH to match the number of transmitted coded bits with the amount of resources allocated for the PDCCH. For example, FIG. 7 illustrates the use of a circular buffer rate matcher 700, according to one embodiment of the present disclosure. As shown in FIG. 7, each of the coded bit streams from the three (3) generator polynomials of the TBCC—dₖ⁽¹⁾, dₖ⁽²⁾, and dₖ⁽³⁾—is interleaved by a sub-block interleaver 702-706. The three interleaved coded bit streams are collected and put into a circular buffer 708. Starting from a certain bit position (e.g., the first bit) in the circular buffer 708, the rate matcher 700 selects the number of coded bits used to match the amount of resource allocated for transmission of a PDCCH. If the last bit in the circular buffer 708 is selected and still more coded bits are needed, the rate matcher 700 may start over from the first bit and continue the bit selection, hence the name “circular buffer”.

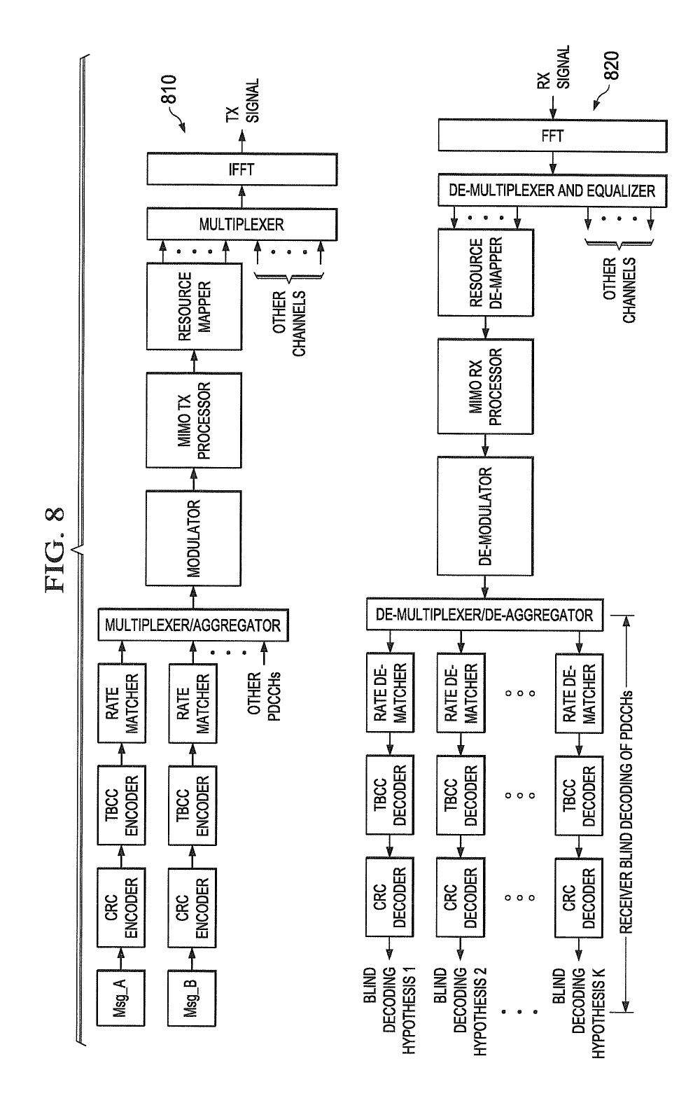

In LTE and LTE-A systems, multiple PDCCHs can be transmitted in one subframe. FIG. 8 illustrates a transmitter and a receiver configured to process (transmit and receive) multiple PDCCHs according to one embodiment of the present disclosure. As shown in (a) of FIG. 8, a base station 810 (eNB in LTE and LTE-A) may transmit multiple PDCCHs by multiplexing the PDCCHs and mapping the modulation symbols for the PDCCHs to different time-frequency resources. In order to achieve good performance in the PDCCH, PDCCH messages may be transmitted using different message sizes and different amounts of resources to satisfy the requirements of sending different messages to UEs with different channel conditions. It would be cumbersome and inefficient if the transmission format for each PDCCH needed to be signaled to the corresponding intended UE (or UEs). Instead, in LTE systems, only a total amount of resources allocated for the PDCCH is signaled by a PCFICH (Physical Control Format Indicator Channel). The UEs employ blind decoding to detect the PDCCH.

One illustration of UE blind decoding of PDCCH is shown in (b) of FIG. 8. There are a limited number of possibilities where a PDCCH can be transmitted, and a limited number of possible PDCCH message formats (Downlink Control Information formats). In addition, to limit the total number of blind decoding processes a UE 820 performs, the number of possibilities where a PDCCH can be transmitted to a specific UE and the DCI formats a specific UE needs to detect are further limited. The UE 820 attempts decoding of a PDCCH message, assuming a possible DCI format on a possible resource location. If the UE 820 is able to successfully decode the message, the CRC for the message should check. Moreover, if the PDCCH message is intended for the UE 820, the CRC scrambling sequence should match with the RNTI of the UE 820. The UE 820 can attempt decoding of the PDCCH assuming all possible combinations of DCI formats and resource locations that are eligible for that UE. By doing so, the eNB can eliminate the extra signaling of the DCI formats and the location of the messages to corresponding UEs.

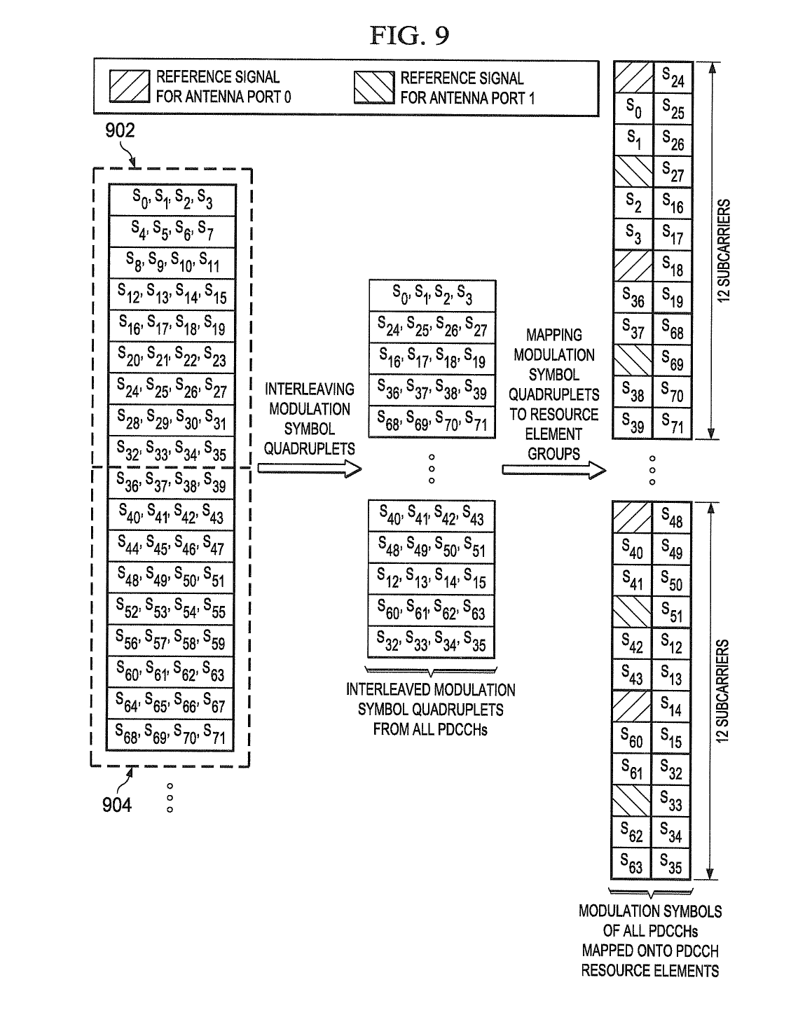

FIG. 9 illustrates how multiple PDCCHs are multiplexed and mapped to time-frequency resources in LTE and LTE-A, according to one embodiment of the present disclosure. Upon encoding, rate matching, scrambling, modulation, and MIMO processing, modulation symbol quadruplets are formed. The modulation symbol quadruplets are interleaved and mapped to the resource element groups. In the embodiment illustrated in FIG. 9, every resource element group (REG) includes four (4) resource elements for data transmission. So, every REG can carry one modulation symbol quadruplet.

A physical control channel is transmitted on an aggregation of one or several consecutive control channel elements (CCEs), where a control channel element corresponds to nine (9) resource element groups. In other words, every CCE corresponds to nine (9) modulation symbol quadruplets, which in turn corresponds to thirty-six (36) modulation symbols. For example, as shown in FIG. 9, a first PDCCH 902 is transmitted using thirty-six (36) modulation symbols s0-s35, which are transmitted on nine (9) resource element groups. The nine (9) resource element groups form a first CCE. A second PDCCH 904 is transmitted using another 36 modulation symbols s36-s71, which are transmitted on another nine (9) resource element groups. These nine (9) resource element groups form a second CCE.

In LTE and LTE-A, the number of resource element groups not assigned to PCFICH or PHICH is N_{REG}. The CCEs available in the system are numbered from zero (0) to N_{CCE}−1, where N_{CCE}└N_{REG}/9┘. The PDCCH supports multiple formats as listed in Table 1 below. A PDCCH consisting of n consecutive CCEs may only start on a CCE fulfilling i mod n=0, where i is the CCE number and mod is the modulo operator. Multiple PDCCHs can be transmitted in a subframe.

TABLE 1
Supported PDCCH formats in LTE

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

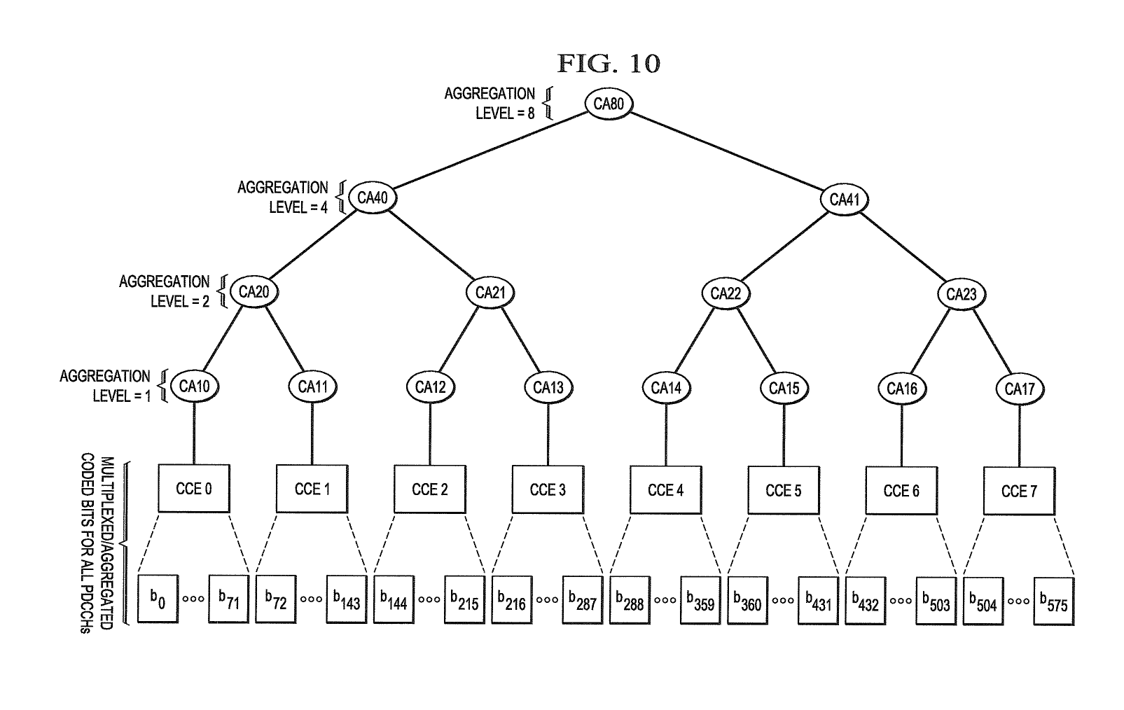

FIG. 10 illustrates a CCE aggregation in LTE and LTE-A according to one embodiment of the present disclosure. A PDCCH message, referred to as a Downlink Control Information (DCI), may be transmitted using one (1), two (2), four (4), or eight (8) CCEs. A PDCCH consisting of n consecutive CCEs may only start on a CCE fulfilling i mod n=0, where i is the CCE number. As a result, the CCE aggregation exhibits a tree structure as shown in FIG. 10.

The LTE system provides a number of mechanisms to prevent PDCCH detection error events. For example, scrambling the CRC of a PDCCH with the RNTI of the intended UE (or UEs) will only allow the intended UE (or UEs) to detect the PDCCH and pass the CRC error detection successfully while other UEs will either not be able to detect the PDCCH or not be able to pass the CRC error detection. In addition, measures are taken to limit the number of blind decoding, which reduces the probability of CRC false detection (the error event that CRC checks for an erroneous PDCCH detection). For example, a PDCCH consisting of n consecutive CCEs may only start on a CCE fulfilling i mod n=0, where i is the CCE number. In summary, the PDCCH is designed such that the intended UE (or UEs) can blindly detect the PDCCH successfully with high probability.

LTE-A systems support carrier aggregation and cross-carrier scheduling. In an LTE-A system with carrier aggregation, each carrier is called a component carrier. In order for the PDCCH messages in one downlink component carrier to schedule downlink transmission in another downlink component carrier, or to schedule uplink transmission in an uplink component carrier that is paired with another downlink component carrier, the carrier indication field (CIF) is needed in the PDCCH message for cross-carrier scheduling purpose.

In accordance with this disclosure, methods and apparatus to encode and decode a carrier indication field in a control channel message in a multi-carrier communication system are provided.

FIG. 11 illustrates a transmitter configured to perform a CIF encoding process, according to one embodiment of the present disclosure. The transmitter 1100 changes the order of the bits in a control channel message depending on the intended component carrier of the control channel message. Like the transmitter 600 of FIG. 6, the transmitter 1100 includes a CRC encoder 1102, a TBCC encoder 1104, a rate matcher 1106, a multiplexer/aggregator 1108, a scrambler 1110, a modulator 1112, a MIMO TX processor 1114, and a resource mapper 1116. The transmitter 1100 also includes a CIF encoder 1103. Encoding by the CIF encoder 1103 will now be described in greater detail.

Denote the bits of the control channel message as m₀, m₁, . . . , m_{N-1}, where N is the number of bits of the control channel message. Examples of a control channel message are the Downlink Control Information (DCI) or Uplink Control Information (UCI) as in a 3 GPP LTE-A system. More specifically, if carrier aggregation is deployed and cross-carrier scheduling is enabled, the downlink scheduling grant (one type of DCI) or uplink scheduling grant (one type of UCI) may need to allocate resources for transmission in different component carriers. Instead of carrying the carrier indication explicitly as payload in the control channel message, the transmitter 1100 may change the order of the control channel message depending on the intended component carrier. The step of changing the order of bits depending on the intended carrier is executed by the CIF encoder 1103.

In order to facilitate error detection, the CRC encoder 1102 attaches a CRC to the message before the CIF encoding. The CRC generator polynomial may be denoted as g(x)=g₀x^{L-1}+g₁x^{L-2}+ . . . +g_{L-2}x+g_{L-1} where L is the length of the CRC. For example, for LTE systems, L equals sixteen (16). The CRC of the N-bit message m(x) is denoted by p(x). The CRC is the remainder of dividing m(x)·x^{L} by g(x). Let q(x) be the quotient of dividing m(x)·x^{L} by g(x). The CRC is computed such that m(x)·x^{L}=q(x)·g(x)+p(x). For a binary system, the relationship can also be written as m(x)·x^{L}+p(x)=q(x)·g(x). The CRC is often masked by the identifier of the intended receiver (or receivers). The identifier may be denoted as r(x). Thus, the CRC-encoded message is denoted as c(x)=m(x)·x^{L}+p(x)+r(x) with total number of bits being N+L.

The CRC-encoded message is then encoded by the CIF encoder 1103. The total number of bits of the CRC encoded message is N+L, which serves as an input to the CIF encoder 1103. The CRC encoded message is denoted as c(x)=c₀x^{N+L-1}+c₁^{N+L-2}+ . . . +c_{N+L-2}x+c_{N+L-1}.

In one embodiment, the CRC-encoded message is cyclically shifted according to the intended carrier of the message. For example, if the intended carrier is carrier 0, c₀(x)=c(x) is transmitted. If the intended carrier is carrier 1, a cyclically shifted version of the message is transmitted. For example, c₁(x)=c₁x^{N+L-1}+c₂x^{N+L-2}+ . . . +c_{N+L-1}x+c₀ is transmitted. Similarly, if the intended carrier is carrier 2, c₂(x)=c₂x^{N+L-1}+c₃x^{N+L-2}+ . . . +c₀x+c₁ is transmitted. If the intended carrier is carrier 3, c₃(x)=c₃x^{N+L-1}+c₄x^{N+L-2}+ . . . +c₁x+c₂ is transmitted. If the intended carrier is carrier 4, c₄(x)=c₄x^{N+L-1}+c₅x^{N+L-2}+ . . . +c₂x+c₃ is transmitted.

The transmitter 1100 is in communication with a receiver, such as the receiver 820 in FIG. 8. The receiver receives the encoded message from the transmitter 1100, and may perform blind decoding of the CIF value and use the CRC to detect the correct hypothesis. Because of the TBCC structure, the trellis of cₖ(x),k=0, 1, 2, 3, 4 includes cyclically-shifted versions of one another. This means that the receiver does not need to know the intended carrier to correctly decode the CRC encoded message. Upon FEC decoding, the ambiguity of the carrier indicator is detected by using the CRC. For example, the receiver may try CRC decoding assuming five (5) different starting position of the trellis.

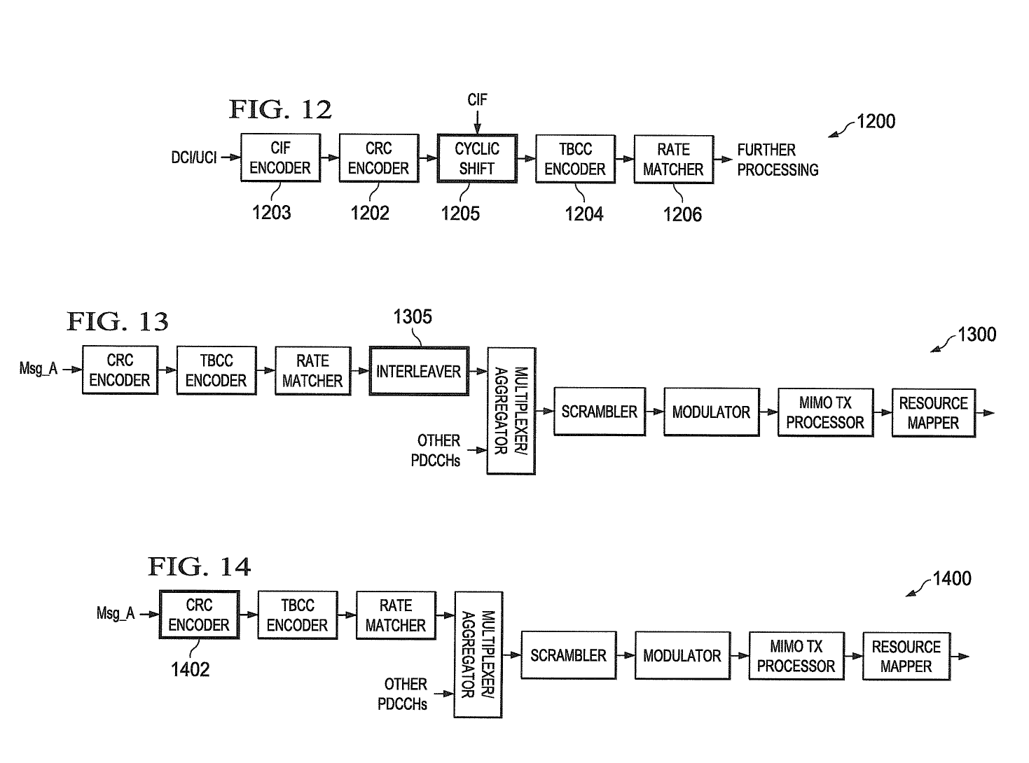

FIG. 12 illustrates a transmitter configured to perform a different CIF encoding process, according to one embodiment of the present disclosure. Like the transmitter 1100 of FIG. 11, the transmitter 1200 includes a CRC encoder 1202, a TBCC encoder 1204, a rate matcher 1206, and a CIF encoder 1203. Other components of the transmitter 1200 that are the same or similar to those of the transmitter 1100 are omitted here for ease of explanation. The transmitter 1200 also includes a cyclic shift block 1205.

In this embodiment, the transmitter 1200 may encode the value of a CIF in a PDCCH message, append a CRC to the PDCCH message, cyclically shift the PDCCH message (including the CIF and the CRC fields) according to the value of the CIF (or equivalently, the intended component carrier of the PDCCH message), and then encode the output by a tail-biting convolutional code. The CIF encoder 1203 may perform encoding as simple as inserting the CIF field in the PDCCH message. In other embodiments, a more sophisticated CIF encoder may be used. For example, assume that the Carrier Indication Field is three (3) bits. A three-bit CRC may be generated based on the other fields of the PDCCH message. Then the three-bit CIF value is used to mask (i.e., bit-wise XOR) the three-bit CRC. The CRC encoder 1202 may be the same sixteen-bit CRC encoder as in LTE systems to maintain backward compatibility and to reduce implementation complexity.

The cyclic shift block 1205 performs the cyclic shift, which is driven by the CIF value. In other words, different amount of cyclic shift is applied for different CIF values. At the receiver side, because of the property of the TBCC, the receiver can decode the TBCC without the knowledge of the CIF value. Upon decoding of the TBCC, the receiver attempts blind decoding of the CRC assuming different possible hypotheses of the CIF value (or equivalently, the intended component carrier of the PDCCH message). If the CRC checks, the receiver can further compare the decoded CIF value that is embedded in the PDCCH message with the assumed hypothesis of the CIF value to ensure the PDCCH message is received correctly.

FIG. 13 illustrates a transmitter configured to perform CIF encoding using interleaving, according to one embodiment of the present disclosure. As shown in FIG. 13, the transmitter 1300 includes many of the same or similar elements as the transmitter 600 in FIG. 6. Descriptions of these elements are omitted for ease of explanation.

The transmitter 1300 also includes an interleaver block 1305. The interleaver block 1305 interleaves a PDCCH message using an interleaving pattern that is dependent on the intended component carrier (or the value of the Carrier Indication Field) of the PDCCH message.

To transmit a PDCCH message (“Msg_A” as shown in the figure), the transmitter 1300 may add CRC to the message, encode the message using FEC schemes such as TBCC, and rate-match the bit selection for transmission with the amount of resources allocated for the transmission. Additionally, the ordering of the bits selected is modified based on the intended component carrier of the PDCCH message.

FIG. 14 illustrates a transmitter configured to perform CRC encoding depending on the CIF value, according to one embodiment of the present disclosure. As shown in FIG. 14, the transmitter 1400 includes many of the same or similar elements as the transmitter 600 in FIG. 6. Descriptions of these elements are omitted for ease of explanation.

The CRC encoder 1402 of transmitter 1400 uses a CRC that depends on the CIF field of the PDCCH message. Thus, the CRC encoder 1402 changes the CRC encoding depending on the intended component carrier of the PDCCH message. A first CRC generator polynomial is used to calculate the CRC for a first PDCCH that carries a scheduling grant for a first component carrier (CC). A second CRC generator polynomial that is different from the first CRC generator polynomial is used to calculate the CRC for a second PDCCH that carries a scheduling grant for a second component carrier. By doing so, the CIF field detection can be achieved by blind decoding between the two different CRC generator polynomials. Note that the first CRC generator polynomial and the second CRC generator polynomial may or may not have the same length.

In another embodiment, a transmitter uses different sequences to scramble the CRC of a PDCCH depending on the CIF value of the PDCCH message. For example, the transmitter transmits two PDCCHs to the same intended UE (or UEs). The first PDCCH carries a scheduling grant for a first component carrier while the second PDCCH carries scheduling grant for a second component carrier. These two PDCCHs may be transmitted either in the same subframe or in different subframes. The message of the first PDCCH may be denoted by:

d₀⁽¹⁾, d₁⁽¹⁾, . . . d_{M1-1}⁽¹⁾

and the message of the second PDCCH may be denoted by:

d₀⁽²⁾, d₁⁽²⁾, . . . d_{M2-1}⁽²⁾

where M1 is the size of the message of the first PDCCH, and M2 is the size of the message of the second PDCCH. These two messages may or may not have the same size. The sixteen-bit CRC of the first PDCCH may be denoted by:

c₀⁽¹⁾, c₁⁽¹⁾, . . . , c₁₅⁽¹⁾,

and the sixteen-bit CRC of the second PDCCH may be denoted by:

c₀⁽²⁾, c₁⁽²⁾, . . . , c₁₅⁽²⁾.

Generally, the first CRC should be generated such that the polynomial:

d₀⁽¹⁾x^{M}^{₁}⁺¹⁵+d₁⁽¹⁾x^{M}^{₁}⁺¹⁴+ . . . +d_{M}_{₁}₋₁⁽¹⁾x¹⁶+c₀⁽¹⁾x¹⁵+c₁⁽¹⁾x¹⁴+ . . . +c₁₅⁽¹⁾

that represents the concatenation of the first message and the first CRC is divisible by the CRC generator polynomial. Likewise, the second CRC should be generated such that the polynomial:

d₀⁽²⁾x^{M}^{₂}⁺¹⁵+d₁⁽²⁾x^{M}^{₂}⁺¹⁴+ . . . +d_{M}_{₂}₋₁⁽²⁾x¹⁶+c₀⁽²⁾x¹⁵+c₁⁽²⁾x¹⁴+ . . . +c₁₅⁽²⁾

that represents the concatenation of the second message and the second CRC is divisible by the CRC generator polynomial.

One example of using different CRC scrambling sequences for different component carriers is shown in Table 2. For example, for the first PDCCH that carries a first message intended for a first component carrier, upon generation of the first CRC, the 16-bit CRC is scrambled by a first sequence a₀⁽¹⁾a₁⁽¹⁾ . . . a₁₅⁽¹⁾. For example, the scrambling can be done by a bit-wise XOR operation. As a result, the first message including the scrambled CRC becomes

d₀⁽¹⁾x^{M}^{₁}⁺¹⁵+d₁⁽¹⁾x^{M}^{₁}⁺¹⁴+ . . . +d_{M}_{₁}₋₁⁽¹⁾x¹⁶+(c₀⁽¹⁾⊕a₀⁽¹⁾)x¹⁵+(c₁⁽¹⁾⊕a₁⁽¹⁾)x¹⁴+ . . . +(c₁₅⁽¹⁾⊕a₁₅⁽¹⁾)

TABLE 2
Different CRC scrambling sequences for
different Carrier Indication

| | Scrambling |
|---|---|
| CIF value | sequence |
| 0 | a₀⁽¹⁾a₁⁽¹⁾ . . . a₁₅⁽¹⁾ |
| 1 | a₀⁽²⁾a₁⁽²⁾ . . . a₁₅⁽²⁾ |
| 2 | a₀⁽³⁾a₁⁽³⁾ . . . a₁₅⁽³⁾ |
| 3 | a₀⁽⁴⁾a₁⁽⁴⁾ . . . a₁₅⁽⁴⁾ |

Similarly, for the second PDCCH that carries a second message intended for a second component carrier, upon generation of the second CRC, the 16-bit CRC is scrambled by a second sequence a₀⁽²⁾a₁⁽²⁾ . . . a₁₅⁽²⁾. For example, the scrambling can be done by bit-wise a XOR operation. As a result, the second message including the scrambled CRC becomes

d₀⁽²⁾x^{M}^{₂}⁺¹⁵+d₁⁽²⁾x^{M}^{₂}⁺¹⁴+ . . . +d_{M}_{₂}₋₁⁽²⁾x¹⁶+(c₀⁽²⁾⊕a₀⁽²⁾)x¹⁵+(c₁⁽²⁾⊕a₁⁽²⁾)x¹⁴+ . . . +(c₁₅⁽²⁾⊕a₁₅⁽²⁾)

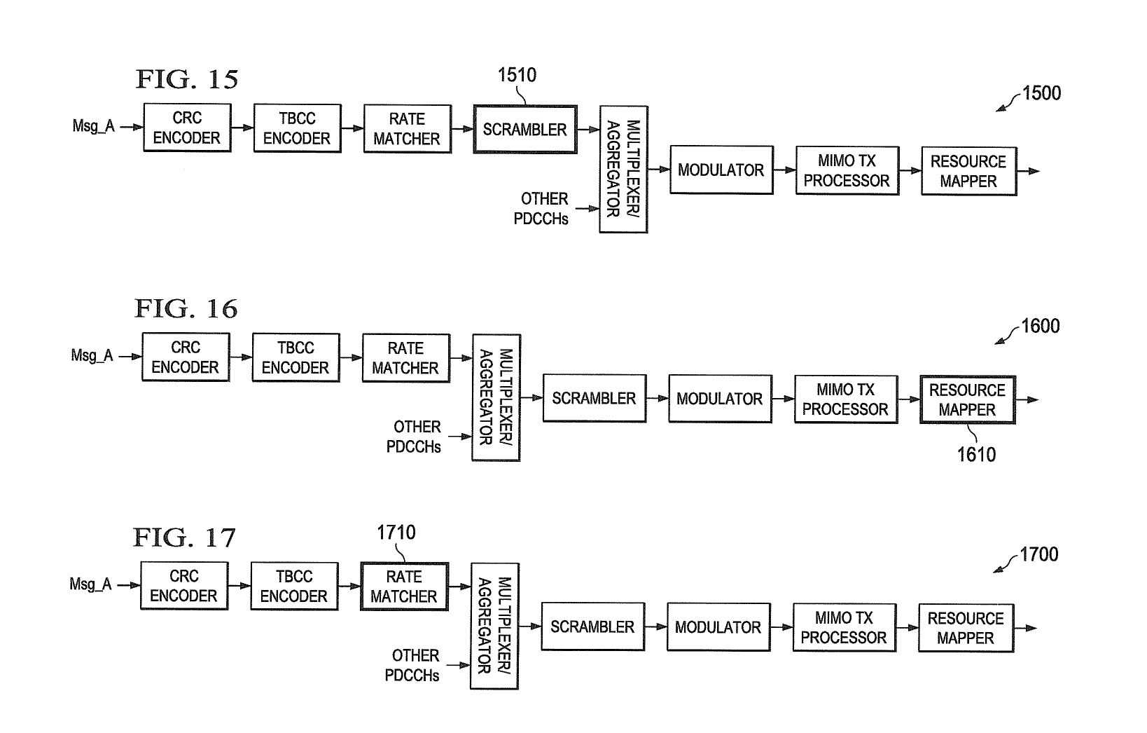

FIG. 15 illustrates a transmitter that uses different PDCCH scrambling depending on the component carrier the PDCCH message is intended for, according to one embodiment of the present disclosure. As shown in FIG. 15, the transmitter 1500 includes many of the same or similar elements as the transmitter 600 in FIG. 6. Descriptions of these elements are omitted for ease of explanation. The transmitter 1500 also includes a scrambler block 1510, which will now be described in detail.

The scrambler block 1510 is configured to change scrambling depending on the CIF value. In an LTE/LTE-A system, when a first PDCCH message intended for a first component carrier is transmitted, N₁ coded bits are selected from the circular buffer of the TBCC coded bits. These N₁ coded bits, denoted by b₀, b₁, . . . , b_{N}_{₁}₋₁ may be scrambled in the scrambler block 1510 using a first scrambling sequence. The first scrambling sequence may be denoted by c₀⁽¹⁾, c₁⁽¹⁾, . . . , cₙ_{₁}₋₁⁽¹⁾. The output of the scrambler block 1510 using the first scrambling sequence may be denoted by b₀⁽¹⁾, b₁⁽¹⁾, . . . , b_{N}_{₁}₋₁⁽¹⁾, where bᵢ⁽¹⁾=cᵢ⁽¹⁾⊕bᵢ, i=0, 1, . . . , N₁−1.

When a second PDCCH message intended for a second component carrier is transmitted, N₂ coded bits are selected from the circular buffer. These N₂ bits, denoted by b₀, b₁, . . . , b_{N2-1}, may be scrambled in the scrambler block 1510 using a second scrambling sequence. The second scrambling sequence may be denoted by c₀⁽²⁾, c₁⁽²⁾, . . . , c_{N}_{₂}₋₁⁽²⁾. The output of the scrambler block 1510 using the second scrambling sequence may be denoted by b₀⁽²⁾, b₁⁽²⁾, . . . , c_{N}_{₂}₋₁⁽²⁾, where bᵢ⁽²⁾=cᵢ⁽²⁾⊕bᵢ, i=0, 1, . . . , N₂−1.

A receiver (e.g., a UE in LTE/LTE-A downlink) may attempt blind decoding of the message. In order to minimize a detection error of confusing the first PDCCH message with the second PDCCH message, the first scrambling sequence and the second scrambling sequence should be designed such that the bit sequence b₀⁽¹⁾, b₁⁽¹⁾, . . . , b_{N}_{₁}₋₁⁽¹⁾ is different from the bit sequence b₀⁽²⁾, b₁⁽²⁾, . . . , b_{N}_{₂}₋₁⁽²⁾. Preferably, the bit-wise difference should be substantial to minimize the possibility of confusing the first PDCCH message with the second PDCCH message.

Many scrambling sequences can achieve such a purpose. For example, the transmitter 1500 may cyclically shift an original scrambling sequence by a different offset depending on the intended component carrier of the PDCCH message. For example, the transmitter 1500 may cyclically shift the original scrambling sequence by zero (0) bits if a first component carrier is the intended component carrier of a PDCCH message. Alternatively, the transmitter 1500 may cyclically shift the original scrambling sequence by one (1) bit if a second component carrier is the intended component carrier of a PDCCH message, or by two (2) bits if a third component carrier is the intended component carrier of a PDCCH message. Then, the cyclically shifted scrambling sequence is used to scramble the selected coded bits of a PDCCH message.

Alternatively, the coded bits can be cyclically shifted before being scrambled by the original scrambling sequence. Similarly, at the receiver side, the receiver will cyclically shift the scrambling sequence before applying the scrambling sequence to descramble the received coded bits. Alternatively, the receiver can cyclically shift the received coded bits before applying the original scrambling sequence to descramble the received coded bits.

FIG. 16 illustrates a transmitter that changes resource mapping depending on the intended carrier, according to one embodiment of the present disclosure. As shown in FIG. 16, the transmitter 1600 includes many of the same or similar elements as the transmitter 600 in FIG. 6. Descriptions of these elements are omitted for ease of explanation. The transmitter 1600 also includes a resource mapper block 1610.

The resource mapper block 1610 may change the mapping from modulation symbol to resource element (RE) within each resource element group (REG) for a PDCCH message depending on the intended component carrier of the PDCCH message (e.g., as indicated by the CIF). One example will now be discussed.

In an embodiment, each resource element group has four (4) REs. The four (4) REs may be denoted by (k₀, 1), (k₁, 1), (k₂, 1), and (k₃, 1), with k₀<k₁<k₂<k₃ being the subcarrier indices of the four (4) REs in increasing order, and 1 being the index of the OFDM symbol in which the four (4) REs of the same resource element group are located. Mapping pattern 1 is used if the intended component carrier of the transmitted PDCCH message is the first component carrier. Mapping patterns 2, 3, and 4 are used if the intended component carrier of the transmitted PDCCH message is the second, third, and fourth component carrier, respectively.

In LTE/LTE-A systems, given the space-frequency block coding (SFBC) (for 2-TX systems) or SFBC with frequency shift time diversity (SFBC-FSTD) (for 4-TX systems) scheme used for PDCCH transmission, one example of four (4) mapping patterns compatible with such MIMO schemes is defined as in Table 3. The mapping patterns achieve different mapping from modulation symbols to REs for different component carriers.

TABLE 3
Multiple mapping patterns compatible with
SFBC/SFBC-FSTD

| | Mapping | Mapping | Mapping | Mapping |
|---|---|---|---|---|
| RE | Pattern | Pattern | Pattern | Pattern |
| index | 1 | 2 | 3 | 4 |
| (k₀, l) | s₀ | s₁ | s₂ | s₃ |
| (k₁, l) | s₁ | s₀ | s₃ | s₂ |
| (k₂, l) | s₂ | s₃ | s₀ | s₁ |
| (k₃, l) | s₃ | s₂ | s₁ | s₀ |

FIG. 17 illustrates a transmitter that changes rate matching depending on the intended carrier, according to one embodiment of the present disclosure. As shown in FIG. 17, the transmitter 1700 includes many of the same or similar elements as the transmitter 600 in FIG. 6. Descriptions of these elements are omitted for ease of explanation. The transmitter 1700 also includes a rate matcher block 1710.

The transmitter 1700 may shift (or cyclically shift) the starting position in the TBCC circular buffer for choosing the coded bits for transmission in the PDCCH. The shift depends on the intended component carrier (e.g., as indicated by the CIF) of the PDCCH message. The coded bits in the circular buffer at the output of TBCC (possibly undergoing further processing such as sub-block interleaving as shown in FIG. 7) may be denoted as w₀, w₁, . . . , w_{L-1} where L is the circular buffer size.

In an LTE/LTE-A system, assume N coded bits are selected from the circular buffer of the TBCC coded bits to transmit a PDCCH message. If a first component carrier is the intended component carrier of a first PDCCH message, the transmitter 1700 may start with an offset position p₀, and select the bit sequence wₚ_{₀}, w₍ₚ_{₀}_{+1)mod L}, . . . , w₍ₚ_{₀}_{+N-1)mod L} for transmission. Similarly, when a receiver attempts blind decoding of a PDCCH message intended for the first component carrier, the receiver puts the received soft bits into the corresponding positions of wₚ_{₀}, w₍ₚ_{₀}_{+1)mod L}, . . . , w₍ₚ_{₀}_{+N-1)mod L} in the circular buffer. It is noted that the modular operation in the position indices is due to the nature of circular buffer—once reaching the last position of the circular buffer, the read and write operation wraps around to the first position of the buffer.

Similarly, if a second component carrier is the intended component carrier of a second PDCCH message, the transmitter 1700 may start with an offset position p₁≠p₀, and select the bit sequence for wₚ_{₁}, w₍ₚ_{₁}_{+1)mod L}, . . . , w₍ₚ_{₁}_{+N-1)mod L} transmission. Similarly, when a receiver attempts blind decoding of a PDCCH message intended for the second component carrier, the receiver puts the received soft bits into the corresponding positions of wₚ_{₁}, w₍ₚ_{₁}_{+1)mod L, . . . , w}₍ₚ_{₁}_{+N-1)mod L} in the circular buffer.

An example of the offset positions is shown in Table 4.

TABLE 4
Rate matching starting positions depending on
Carrier Indication Field

| | Starting point position |
|---|---|
| CIF value | in circular buffer |
| 0 | p₀ = 0 |
| 1 | p₁ = 1 |
| 2 | p₂ = 2 |
| 3 | p₃ = 3 |

As described in the various embodiments above, the CIF value may be encoded in PDCCH messages in LTE-A systems. It will be understood to a person of skill in the art that the embodiments of this disclosure may be applied to other message fields in other messages or packets in LTE-A systems or in other communication systems. It is intended that this disclosure cover those applications as well.

Time synchronization is one of the first steps in establishing communication between two devices. Existing wireless communication systems, including WiFi, CDMA/CDMA2000/1xEV-DO, GSM/WCDMA/HSPA, mobile WiMAX, and LTE/LTE-Advanced systems, all have carefully designed time synchronization signals and procedures.

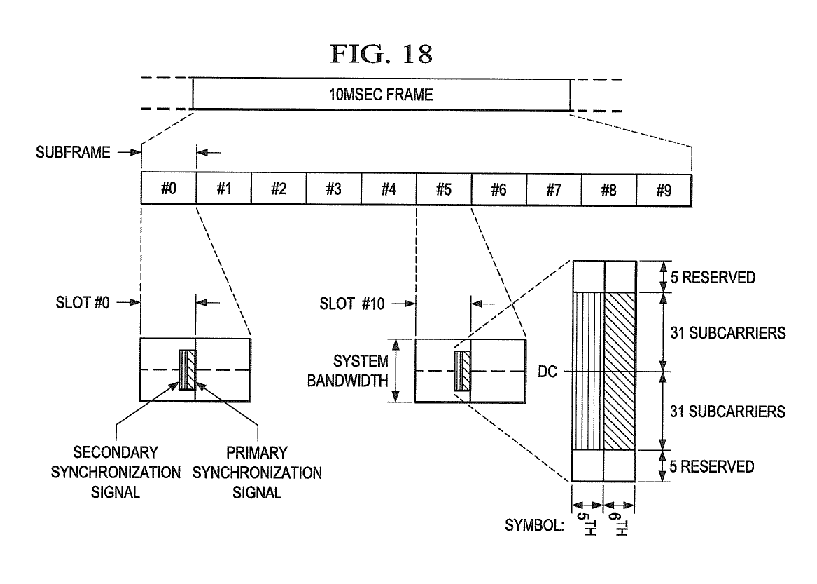

For example, FIG. 18 illustrates synchronization signals in an LTE system. As shown in FIG. 18, the primary synchronization signal (PSS) and secondary synchronization signal (SSS) may be used to allow the mobile station (or user equipment or UE) to synchronize to the timing of the base station.

The PSS and SSS are transmitted in both subframe #0 and subframe #5 in every 10 ms frame. In each occurrence, both the PSS and the SSS occupy the center 72 subcarriers (with five (5) subcarriers on each side reserved).

There are 504 unique physical-layer cell identities. The physical-layer cell identities are grouped into 168 unique physical-layer cell-identity groups, each group containing three unique identities. The grouping is such that each physical-layer cell identity is part of one and only one physical-layer cell-identity group. A physical-layer cell identity N_{ID}^{cell}=3N_{ID}⁽¹⁾+N_{ID}⁽²⁾ is thus uniquely defined by a number ID in the range of 0 to 167, representing the physical-layer cell-identity group; and a number N_{ID}⁽²⁾ in the range of 0 to 2, representing the physical-layer identity within the physical-layer cell-identity group. The information of N_{ID}⁽²⁾ is carried in the PSS while the information of N_{ID}⁽¹⁾ is carried in the SSS.

The sequence used for the PSS is generated from a frequency-domain Zadoff-Chu sequence. The Zadoff-Chu root sequence index is linked to N_{ID}⁽²⁾ which allows the UEs to detect the value of N_{ID}⁽²⁾ by detecting the PSS. The UEs are able to detect the 5 ms timing by detecting the PSS, because the PSS is transmitted periodically every 5 ms.

The sequence used for the SSS is an interleaved concatenation of two binary sequences, each having a length of thirty-one (31). The concatenated sequence is scrambled with a scrambling sequence given by the PSS. The combination of two thirty-one-length sequences defining the SSS differs between subframe 0 and subframe 5 in order for the UEs to detect the 10 ms frame timing. The choice of the two thirty-one-length binary sequences is linked to the physical-layer cell-identity group N_{ID}⁽¹⁾, which allows the UEs to detect the value of the physical-layer cell-identity group N_{ID}⁽¹⁾ by detecting the SSS.

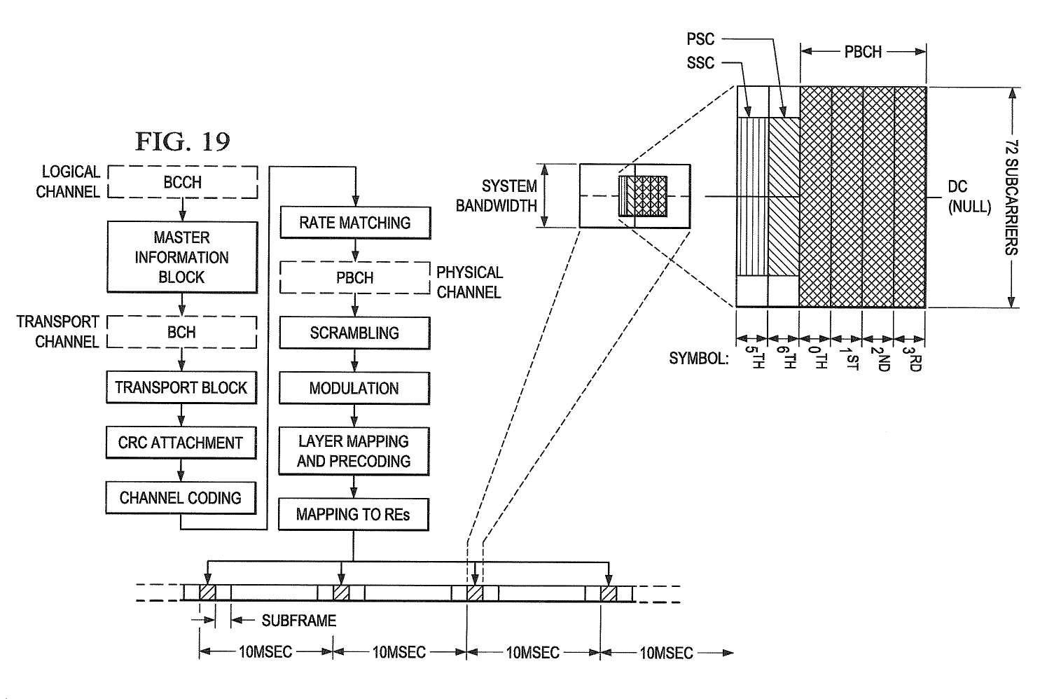

Additionally, the frame boundary and the starting position of the 40 ms (four frames) boundary can be detected via a physical broadcast channel (PBCH). For example, FIG. 19 illustrates a PBCH in LTE systems. As shown in FIG. 19, a PBCH transport block is transmitted in subframe 0 of the four (4) consecutive frames in a 40 ms interval. The PBCH signal is scrambled with a scrambling sequence that is initialized every 40 ms by the cell ID in the first subframe of a frame with a system frame number (SFN) that is a multiple of 4. This design enables the UEs to detect the 40 ms timing by detecting the PBCH.

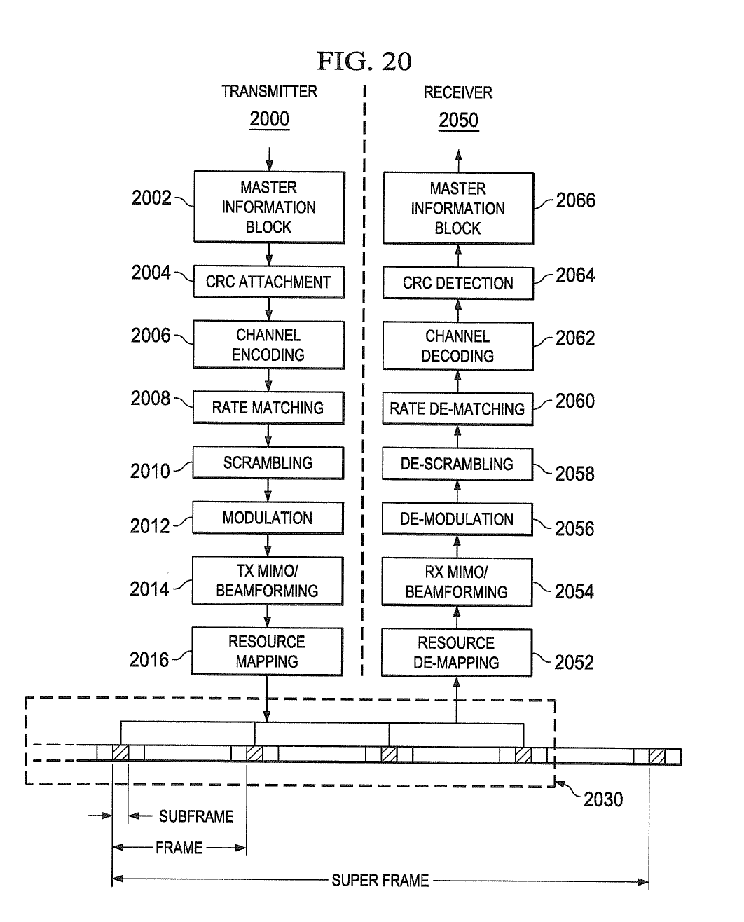

FIG. 20 illustrates a PBCH transmitter and receiver for use in an LTE or LTE-A system. In the transmitter 2000, the Master Information Block (MIB) 2002 carries fundamental system information such as downlink system bandwidth and the system frame number (SFN). After CRC attachment 2004, channel encoding 2006, rate matching 2008, scrambling 2010, modulation 2012, and transmission MIMO/beamforming processing 2014, the modulation symbols are mapped in a resource mapping block 2016 to resource elements allocated for PBCH. The modulation symbols are then transmitted.

The receiver 2050 receives the transmitted symbols and processes the symbols by resource de-mapping 2052, reception MIMO/beamforming processing 2054, de-modulation 2056, de-scrambling 2058, rate de-matching 2060, channel decoding 2062, CRC detection 2064, and extraction of the MIB 2066.

In order to ensure high reliability of PBCH (and thus MIB) reception, each MIB is transmitted across four (4) consecutive frames 2030. In each frame, the PBCH (and thus the MIB) is transmitted in the first subframe. The SFN field in the MIB does not carrier the last two bits of the SFN. In order to facilitate the UE to detect the 40 ms timing, the transmission of the PBCH in each frame is scrambled differently. This is achieved by initializing the scrambling sequence generator by the cell ID once every 40 ms. As a result, the scrambling sequence applied to PBCH transmission in each of the four (4) subframes within a 40 ms interval is different.

When the receiver 2050 receives a PBCH transmission in a subframe, the receiver 2050 blindly detects the 40 ms timing (i.e., which one of the four (4) frames within the 40 ms interval the current subframe belongs to) by attempting decoding of the PBCH assuming different hypotheses of the frame number. In each hypothesis, the receiver 2050 descrambles the PBCH transmission differently and attempts the decoding. In addition, to increase the reliability, the receiver 2050 may combine with previous PBCH transmissions, which also utilizes different descrambling of previous PBCH transmissions for different hypotheses. As a result, this can lead to significant complexity in the 40 ms timing acquisition using a PBCH.

In accordance with embodiments of the present disclosure, fast timing synchronization in a mobile broadband system may be achieved by using cyclic shifts of tail-biting convolutional codes. For the purpose of illustration, the embodiments are described in the context of time synchronization for LTE systems. However, it will be understood that the embodiments are applicable to time or frequency synchronization in other wireless communication systems, including 4 G, beyond 4 G, and 5 G mobile broadband systems.

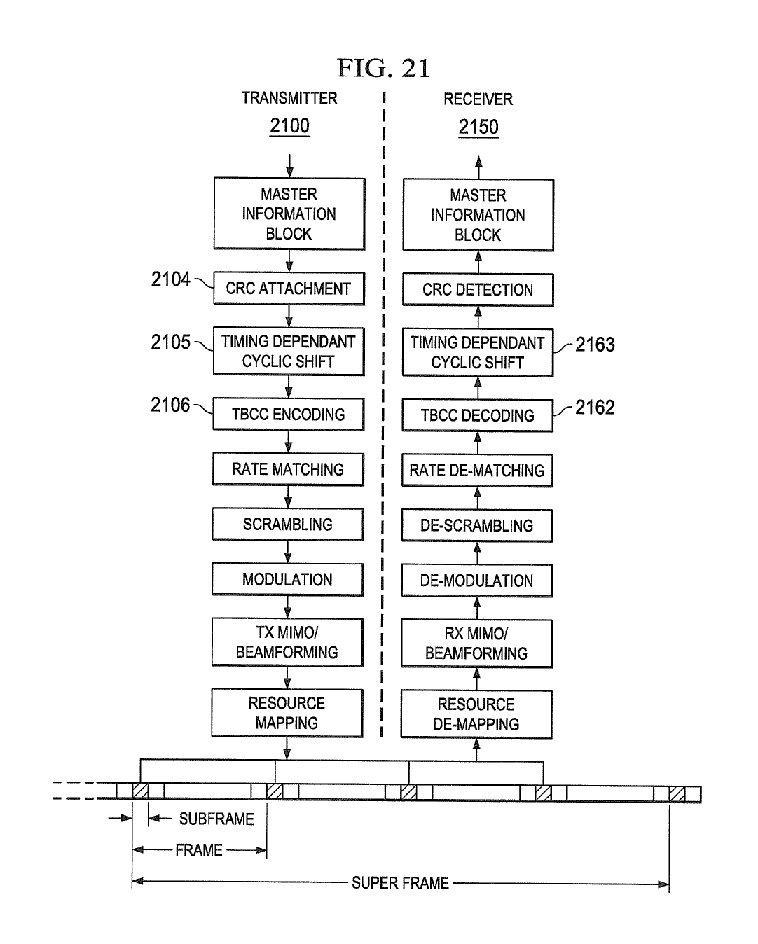

FIG. 21 illustrates encoding of frame timing information using a cyclic shift with TBCC, according to one embodiment of the present disclosure. As shown in FIG. 21, the transmitter 2100 and receiver 2150 include many of the same or similar elements as the transmitter 2000 and receiver 2050 in FIG. 20. Descriptions of these elements are omitted for ease of explanation. The transmitter 2100 also includes a timing dependent cyclic shift block 2105 and a TBCC encoding block 2106. The receiver 2150 includes a TBCC decoding block 2162 and a timing dependent cyclic shift block 2163.

In the embodiment, the frame timing information (e.g., the last two bits of the SFN) of a frame is encoded in the PBCH transmission in the frame by cyclically shifting the PBCH message a number of times. The number of cyclic shifts is determined by the frame timing information. After the message in MIB is encoded with CRC 2104, the message is cyclically shifted in the timing dependent cyclic shift block 2105 by a number of times that equals the last two bits of the SFN. The cyclically shifted message will then go through the TBCC encoding block 2106, then rate matching, scrambling, modulation, transmission MIMO processing, and resource mapping. The message is then transmitted.

Preferably, in order to simplify the complexity of the receiver 2150, the other procedures in the PBCH transmission chain 2100 (including the TBCC encoding 2106, rate matching, scrambling, modulation, Tx MIMO processing, and resource mapping) should not depend on the last two bits of the SFN. For example, in an embodiment, the scrambling sequence generator may be initialized every frame, instead of every four (4) frames. Similarly, in an embodiment, the rate matching may also be done on a per frame basis to allow easy combining of the PBCH transmissions across frames.

Upon receiving a PBCH transmission, the receiver 2150 may attempt decoding of the PBCH with different hypotheses of the 40 ms frame timing (i.e., by attempting different values of the two least significant bits (LSBs) of the SFN). Since the scrambling sequence generator is initialized by the cell ID in each frame, the same scrambling sequence is used to scramble the PBCH transmission in each frame. The receiver 2150 does not need the 40 ms frame timing information to properly descramble the received symbols. After de-scrambling, the receiver 2150 may combine PBCH transmissions across frames by properly cyclically shifting the received coded symbols in these frames, without explicitly knowing the value of the last two LSBs of the SFN for the current frame. This method significantly reduces the complexity of the receiver 2150 in applying different scrambling or blind decoding of the PBCH transmissions.

As an example, assume the MIB is twenty-four (24) bits long, and the CRC is sixteen (16) bits long. The MIB message is denoted as a₀, a₁, a₂, a₃, . . . , a_{A-1}, and the CRC is denoted as p₀, p₁, p₂, p₃, . . . , p_{L-1}. After the CRC attachment, the CRC bits may be additionally scrambled with the sequence x₀, x₁, . . . , x₁₅ to form the sequence of bits c₀, c₁, c₂, c₃, . . . , c_{K-1} where

cₖ=aₖ for k=0, 1, 2, . . . , A−1

cₖ=p_{k-A}⊕x_{k-A} for k=A, A+1, A+2, . . . , A+15.

The additional scrambling of the CRC may be used to carry information such as the base station transmit antenna configuration by using a different CRC scrambling sequence for each base station transmit antenna configuration. In order to avoid an all-zero message after scrambling, the scrambling sequence preferably should not be all-zero. In an embodiment, a non-zero scrambling sequence may be applied in addition to the scrambling sequences that are used to carry information. In other embodiment, all scrambling sequences that are used to carry information are non-zero. It is noted that a non-zero scrambling sequence is a scrambling sequence that has at least one bit being non-zero. Similarly, in order to avoid an all-ones message after scrambling, the scrambling sequence preferably should not be all-ones.

For a PBCH transmission in a frame with the two LSBs being ‘00 ’, no cyclic shift is applied to the message c₀, c₁, c₂, c₃, . . . , c_{K-1}. For a PBCH transmission in a frame with the two LSBs being ‘01 ’, the message c₀, c₁, c₂, c₃, . . . , c_{K-1} is cyclically shifted by 1 bit. The cyclic shift may be either a right cyclic shift or a left cyclic shift. For a right cyclic shift, the resulting message is c_{K-1}, c0, c₁, c₂, . . . , c_{K-2}. For a left cyclic shift, the resulting message is c₁, c₂, c₃, . . . , c_{K-1}, c₀. For the purpose of illustration, the embodiments described below use a left cyclic shift, although a right cyclic shift would also be applicable.

As shown in FIG. 21, the timing dependent cyclic shift block 2105 generates the cyclically shifted message. The message is encoded at the TBCC encoding block 2106 and processed by other steps in the transmitter chain 2100 as shown.

Turning now to the receiver 2150, because the resource de-mapping, Rx MIMO processing, de-modulation, de-scrambling, rate de-matching, and de-coding are independent of the value of the 40 ms frame timing (i.e., the two LSBs of the SFN), the receiver 2150 may proceed with these steps without the information of the frame timing. Once the decoding is complete, the receiver 2150 proceeds with CRC detection assuming different values of cyclic shift. The receiver 2150 uses the CRC to detect which hypothesis of the value of the cyclic shift is correct (and thus detect the value of the two LSBs of the SFN in the 40 ms frame timing). With this method, the receiver 2150 only needs to attempt descrambling and TBCC decoding once per frame. The blind detection of the 40 ms frame timing is achieved by attempting CRC detection with multiple hypotheses of cyclic shift.

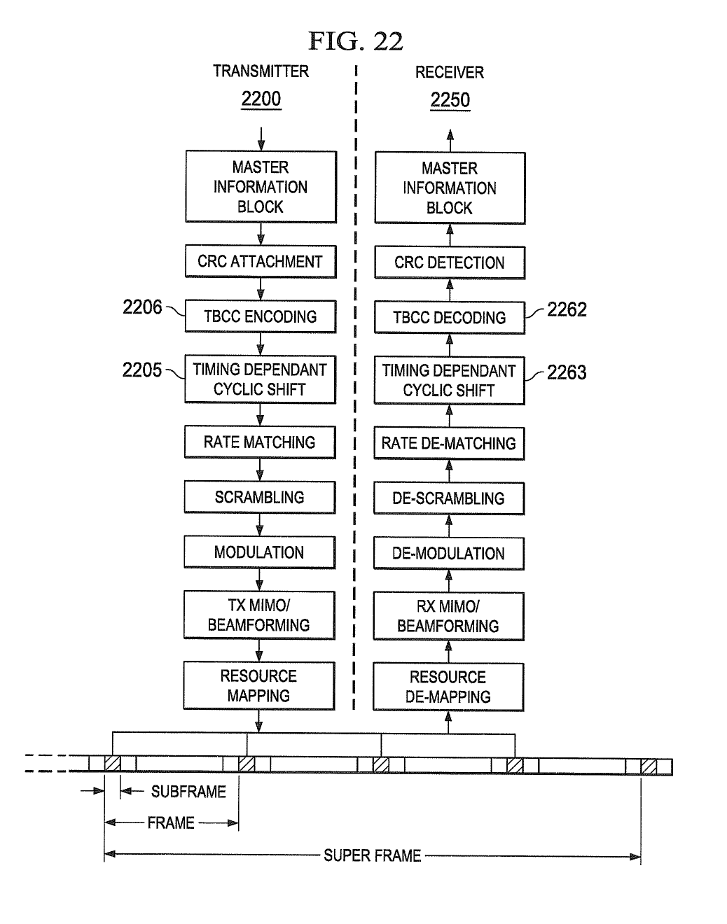

The timing dependant cyclic shift of the message may be implemented in different ways. For example, FIG. 22 illustrates encoding frame timing information using a cyclic shift after TBCC encoding, according to an embodiment of the present disclosure. As shown in FIG. 22, the transmitter 2200 and receiver 2250 include the same or similar elements as the transmitter 2100 and receiver 2150 in FIG. 21. Descriptions of these elements are omitted for ease of explanation. In the transmitter 2200, the timing dependent cyclic shift block 2205 and the TBCC encoding block 2206 have switched order. Likewise, in the receiver 2250, the TBCC decoding block 2262 and the timing dependent cyclic shift block 2263 have switched order.

In FIG. 21, the message c₀, c₁, c₂, c₃, . . . , c_{K-1} is cyclically shifted before the TBCC encoding. Alternatively, in FIG. 22, the cyclic shift is applied to the TBCC encoder output by a cyclic shift along the trellis. In order to encode the frame timing, the number of trellis stages cyclically shifted may be chosen based on the frame timing (e.g., the two LSBs of the SFN). The cyclically shifted TBCC encoder output of the message then proceeds through other processing steps such as rate matching, scrambling, and so forth. This method of encoding the frame timing with cyclic shift of the PBCH message (or equivalently, cyclic shift along the trellis of the TBCC codeword) is illustrated in FIG. 22.

It is mathematically equivalent to cyclically shift the message before the TBCC encoding or to cyclically shift the TBCC encoder output along the trellis. Therefore, it is also possible that the transmitter encodes the frame timing by cyclically shifting the message before the TBCC encoding with the number of cyclic shifts dependant on the frame timing while the receiver attempts detection of the frame timing by cyclically shifting the received coded symbols along the trellis before the TBCC decoding.

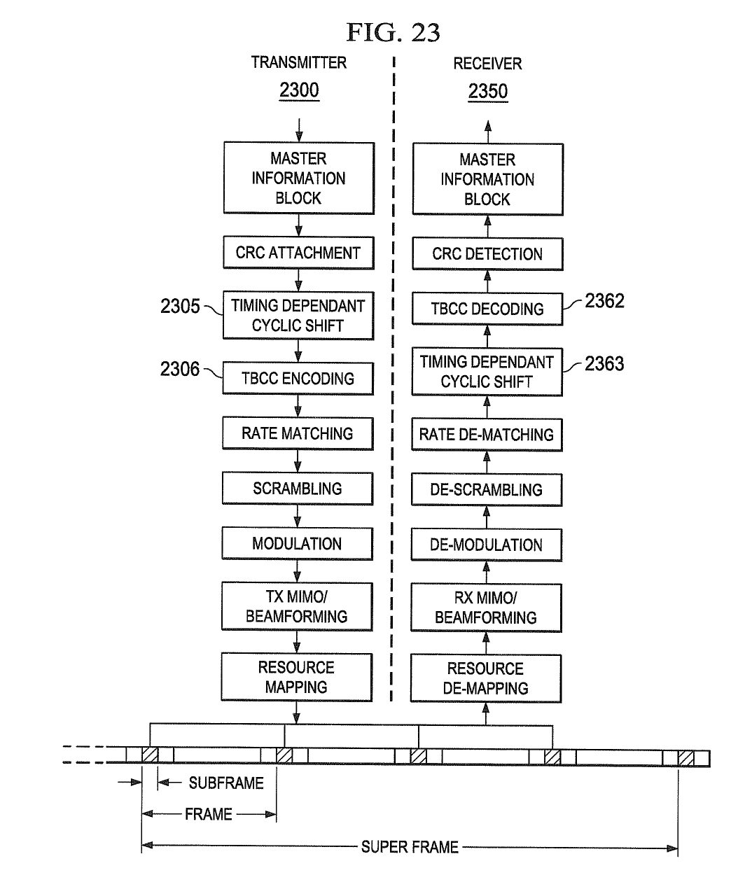

FIG. 23 illustrates an example of this encoding and decoding arrangement, according to an embodiment of the present disclosure. As shown in FIG. 23, the transmitter 2300 and receiver 2350 include the same or similar elements as the transmitter 2100 and receiver 2150 in FIG. 21. Descriptions of these elements are omitted for ease of explanation. In the transmitter 2300, the timing dependent cyclic shift block 2305 and the TBCC encoding block 2306 are arranged in the same order as in the transmitter 2100. However, in the receiver 2350, the TBCC decoding block 2362 and the timing dependent cyclic shift block 2363 have switched order, as compared to the receiver 2150.

In other embodiments, it is possible that the transmitter encodes the frame timing by cyclically shifting the output of the TBCC encoder along the trellis with the number of cyclic shifts dependant on the frame timing, while the receiver attempts detection of the frame timing by cyclically shifting the output of the TBCC decoder according to multiple frame timing hypotheses and then using CRC detection to detect the correct frame timing hypothesis.

In such an embodiment, the cyclic shift operation of the message (or cyclic shift operation of the output branches along the trellis) can be combined with the rate matching procedure, which results in a rate matching procedure dependant on the frame timing. In addition, it is possible that the rate matching procedure may select a portion of the TBCC codeword or multiple repetitions of the TBCC codeword for transmission. However, it is straightforward for the receiver to perform rate de-matching to put the received symbols into the right positions of the TBCC codeword.

For the purpose of illustration, the cyclic shift operations and the rate matching/de-matching as considered separate procedures, although the embodiments described herein are applicable when the cyclic shift operations and the rate matching/de-matching procedures are combined in various ways.

With the frame timing (e.g., the two LSBs of the SFN) encoded in the cyclic shifts of the message (or cyclic shifts of the output branches of the TBCC codeword along the trellis), it is also possible for the receiver to reduce the complexity of PBCH decoding if the receiver attempts soft combining of multiple transmissions of PBCH across multiple frames.

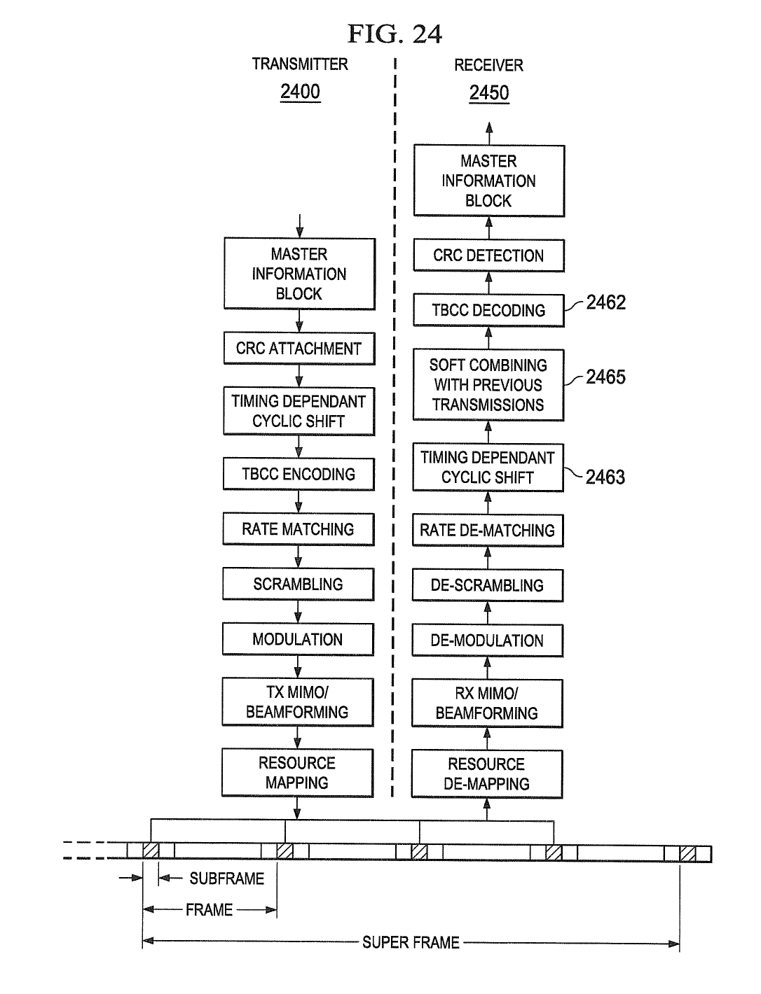

FIG. 24 illustrates soft combining of multiple TBCC-encoded PBCH transmissions with different cyclic shifts, according to one embodiment of the present disclosure. As shown in FIG. 24, the transmitter 2400 and receiver 2450 include many of the same or similar elements as the transmitter 2100 and receiver 2150 in FIG. 21. Descriptions of these elements are omitted for ease of explanation. The receiver 2450 includes a TBCC decoding block 2462 and a timing dependent cyclic shift block 2463 in a different order than in the receiver 2150. Also, the receiver 2450 includes a soft combining block 2465.

The receiver 2450 does not need the information of frame timing to process a PBCH transmission in the resource de-mapping, Rx MIMO/beamforming processing, de-modulation, de-scrambling, and rate de-matching blocks as these blocks are independent of the frame timing information. In the TBCC decoding, the receiver 2450 may attempt soft combining with PBCH transmissions in previous frames to increase the reliability of the detection without knowing the frame timing information.

For example, using a hypothesis that the current frame is the third frame in the 40-ms interval (i.e., the value of the two LSBs of the current frame is ‘10 ’), the receiver 2450 may combine the received symbols in the current frame and the previous two frames as the input to the TBCC decoder 2462 because these three frames should carry the same MIB (i.e., PBCH transport block), assuming the hypothesis is correct. With the de-scrambling and other steps being independent of frame timing, the soft combining may be easily achieved by cyclically shifting the received symbols along the trellis to align the received symbols in different transmissions and then combining the aligned received symbols.

For a message c₀, c₁, c₂, c₃, . . . , c_{K-1}, assuming a TBCC as shown in FIG. 5 is used, there will be three (3) branches of output. The first branch is denoted as d₀⁽⁰⁾, d₁⁽⁰⁾, d₂⁽⁰⁾, d₃⁽⁰⁾, . . . , d_{K-1}⁽⁰⁾, the second branch as d₀⁽¹⁾, d₁⁽¹⁾, d₂⁽¹⁾, d₃⁽¹⁾, d_{K-1}⁽¹⁾, and the third branch as d₀⁽²⁾, d₁⁽²⁾, d₂⁽²⁾, d₃⁽²⁾, . . . , d_{K-1}⁽²⁾.

In a frame with the value of the two (2) LSBs being ‘00 ’, the three branches go through further processing such as rate matching, scrambling, modulation, etc. as described earlier.

In a frame with the value of the two (2) LSBs being ‘01 ’, the three branches are cyclically shifted left by one (1) bit, resulting in three cyclically shifted branches, d₁⁽⁰⁾, d₂⁽⁰⁾, d₃⁽⁰⁾, . . . , d_{K-1}⁽⁰⁾, d₀⁽⁰⁾, d₁⁽¹⁾, d₂⁽¹⁾, d₃⁽¹⁾, . . . , d_{K-1}⁽¹⁾, d₀⁽¹⁾, and d₁⁽²⁾, d₂⁽²⁾, d₃⁽²⁾, . . . , d_{K-1}⁽²⁾, d₀⁽²⁾. These three cyclically shifted branches then go through further processing such as rate matching, scrambling, modulation, etc. Equivalently, the cyclic shift of the three branches (or the cyclic shift of the trellis) can also be achieved by cyclically shifting the message itself.

In a frame with the value of the two (2) LSBs being ‘10 ’, the three branches are cyclically shifted left by two (2) bits, resulting in three cyclically shifted branches, d₂⁽⁰⁾, d₃⁽⁰⁾, d₄⁽⁰⁾, . . . , d₀⁽⁰⁾, d₁⁽⁰⁾, d₂⁽¹⁾, d₃⁽¹⁾, d₄⁽¹⁾, . . . , d₀⁽¹⁾, d₁⁽¹⁾, and d₂⁽²⁾, d₃⁽²⁾, d₄⁽²⁾, . . . , d₀⁽²⁾, d₁⁽²⁾. These three cyclically shifted branches then go through further processing such as rate matching, scrambling, modulation, etc. Equivalently, the cyclic shift of the three branches (or the cyclic shift of the trellis) can also be achieved by cyclically shifting the message itself.

In a frame with the value of the two (2) LSBs being ‘11 ’, the three branches are cyclically shifted left by three (3) bits, resulting in three cyclically shifted branches, d₃⁽⁰⁾, d₄⁽⁰⁾, d₅⁽⁰⁾, . . . , d₁⁽⁰⁾, d₂⁽⁰⁾, d₃⁽¹⁾, d₄⁽¹⁾, d₅⁽¹⁾, . . . , d₁⁽¹⁾, d₂⁽¹⁾, and d₃⁽²⁾, d₄⁽²⁾, d₅⁽²⁾, . . . , d₁⁽²⁾, d₂⁽²⁾. These three cyclically shifted branches then go through further processing such as rate matching, scrambling, modulation, etc. Equivalently, the cyclic shift of the three branches (or the cyclic shift of the trellis) can also be achieved by cyclically shifting the message itself.

The relationship between the cyclic shift in a frame may be established with the frame timing such that the number of cyclic shifts in the first frame of a 40 ms interval is zero (0), the number of cyclic shifts in the second frame of a 40 ms interval is one (1), the number of cyclic shifts in the third frame of a 40 ms interval is two (2), and the number of cyclic shifts in the fourth frame of a 40 ms interval is three (3).

At the receiver side, soft combining may be achieved without knowing the frame timing or the number of cyclic shifts in the current frame. For example, if the receiver is to combine the received symbols of the current frame with the received symbols of the previous frame, the receiver can cyclically shift the received symbols in the previous frame towards the left along the trellis by one (1) bit. The receiver can then combine the cyclically shifted received symbols in the previous frame with the received symbols in the current frame in the same position of the same branch. This method of combining will always achieve the correct combining regardless of the frame timing, as long as the two frames are in the same 40 ms time interval.

For example, if the current frame is the fourth frame of a 40 ms time interval, the received symbols after rate de-matching can be put in three branches along the trellis. These received symbols correspond to d₃⁽⁰⁾, d₄⁽⁰⁾, d₅⁽⁰⁾, . . . , d₁⁽⁰⁾, d₂⁽⁰⁾ for the first branch, d₃⁽¹⁾, d₄⁽¹⁾, d₅⁽¹⁾, . . . , d₁⁽¹⁾, d₂⁽¹⁾ for the second branch, and d₃⁽²⁾, d₄⁽²⁾, d₅⁽²⁾, . . . , d₁⁽²⁾, d₂⁽²⁾ for the third branch. Similarly, in the previous frame, which is the third frame of a 40 ms time interval, the received symbols after rate de-matching can be put in three branches along the trellis. These received symbols correspond to d₂⁽⁰⁾, d₃⁽⁰⁾, d₄⁽⁰⁾, . . . , d₀⁽⁰⁾, d₁⁽⁰⁾ for the first branch, d₂⁽¹⁾, d₃⁽¹⁾, d₄⁽¹⁾, . . . , d₀⁽¹⁾, d₁⁽¹⁾ for the second branch, and d₂⁽²⁾, d₃⁽²⁾, d₄⁽²⁾, . . . , d₀⁽²⁾, d₁⁽²⁾ for the third branch. In order to correctly combine the received symbols in these two frames, the receiver can cyclically shift the received symbols in the previous frame towards the left by one (1) bit, and combine the received symbols in the same position in the same branch across these two frames.

The same conclusion can be drawn if the current frame is the third frame or the second frame of a 40 ms time interval. If the current frame is the first frame of a 40 ms time interval, the receiver should not combine the received symbols in the current frame with the received symbols in any previous frame because the frames would belong to different 40 ms time intervals and thus carry different MIB information bits.

In an embodiment, if the receiver needs to combine the received symbols of the current frame with the received symbols of the previous two frames, the receiver can cyclically shift the received symbols in the previous frame towards the left along the trellis by one (1) bit, and cyclically shift the received symbols in the frame before the previous frame towards the left along the trellis by two (2) bits. The receiver can then combine the cyclically shifted received symbols in the previous two frames with the received symbols in the current frame in the same position in the same branch.

The receiver can correctly perform the aforementioned combining without knowing the actual value of the frame timing. In addition, the receiver can perform the combining without applying different descrambling sequences for each hypothesis. These advantages allow significant complexity reduction in the receiver detection of frame timing.

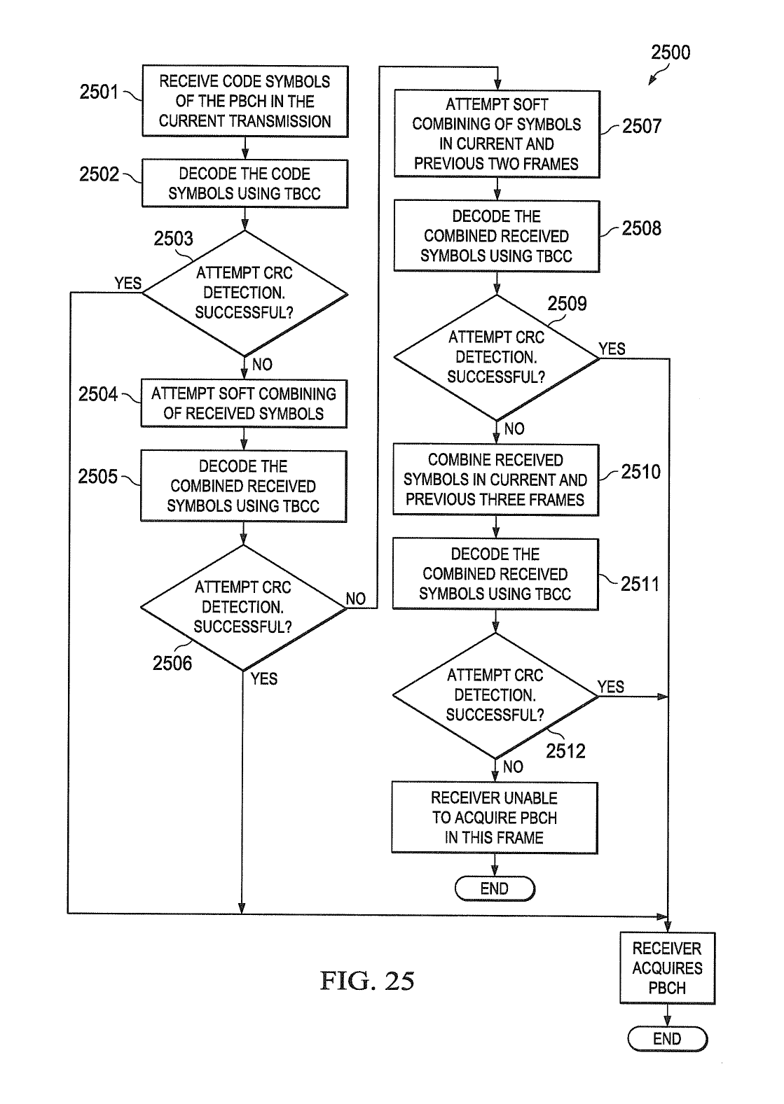

FIG. 25 illustrates a method for a receiver to detect the frame timing (and receive the MIB in the PBCH), according to one embodiment of the present disclosure. For ease of explanation, the receiver may represent one or more of the receivers 2050-2450 in FIGS. 20 through 24, or any other suitable receiver.

The method 2500 starts in block 2501, where the receiver receives the code symbols of the PBCH in the current transmission (including resource de-mapping, Rx MIMO processing, demodulation, descrambling, rate de-matching) and arranges the received symbols into three branches along the trellis. The received symbols may be denoted as r₀⁽⁰⁾, r₁⁽⁰⁾, r₂⁽⁰⁾, r₃⁽⁰⁾, . . . , r_{K-1}⁽⁰⁾ for the first branch, r₀⁽¹⁾, r₁⁽¹⁾, r₂⁽¹⁾, r₃⁽¹⁾, . . . , r_{K-1}⁽¹⁾ for the second branch, and r₀⁽²⁾, r₁⁽²⁾, r₂⁽²⁾, r₃⁽²⁾, . . . , r_{K-1}⁽²⁾ for the third branch of the TBCC codeword.

In block 2502, the receiver decodes the received symbols using TBCC. The decoded bits may be denoted as b₀, b₁, b₂, b₃, . . . , b_{K-1}.

In block 2503, the receiver attempts CRC detection for b₀, b₁, b₂, b₃, . . . , b_{K-1}, b_{K-1}, b₀, b₁, b₂, . . . , b_{K-2}, b_{K-2}, b_{K-1}, b₀, b₁, . . . , b_{K-3}, and b_{K-3}, b_{K-2}, b_{K-1}, b₀, . . . , b_{K-4} in order to detect the frame timing. If the CRC checks for b₀, b₁, b₂, b₃, . . . , b_{K-1}, the current frame is the first frame of a 40 ms time interval. If the CRC checks for b_{K-1}, b₀, b₁, b₂, . . . , b_{K-2}, the current frame is the second frame of a 40 ms time interval. If the CRC checks for b_{K-3}, b_{K-2}, b_{K-1}, b₀, . . . , b_{K-4}, the current frame is the third frame of a 40 ms time interval. If the CRC checks for b_{K-3}, b_{K-2}, b_{K-1}, b₀, . . . , b_{K-4}, the current frame is the fourth frame of a 40 ms time interval. If the CRC does not check for any of the four hypotheses, the method proceeds to block 2504.

In block 2504, the receiver attempts soft combining of the received symbols in the current frame with the received symbols in the previous frame. The receiver may use the following soft combining process:

Part A.

The receiver assigns notations to the received symbols in the previous frame (after resource de-mapping, Rx MIMO processing, demodulation, descrambling, rate de-matching, and so forth). For example, the received symbols in the previous frame may be denoted as s₀⁽⁰⁾, s₁⁽⁰⁾, s₂⁽⁰⁾, s₃⁽⁰⁾, . . . , s_{K-1}⁽⁰⁾ for the first branch, s₀⁽¹⁾, s₁⁽¹⁾, s₂⁽¹⁾, s₃⁽¹⁾, . . . , s_{K-1}⁽¹⁾ for the second branch, and s₀⁽²⁾, s₁⁽²⁾, s₂⁽²⁾, s₃⁽²⁾, . . . , s_{K-1}⁽²⁾ for the third branch of the TBCC codeword.

Part B.

The receiver cyclically shifts the received symbols in the previous frame towards the left along the trellis by one (1) bit, resulting in received symbols s₁⁽⁰⁾, s₂⁽⁰⁾, s₃⁽⁰⁾, . . . , s_{K-1}⁽⁰⁾, s₀⁽⁰⁾ for the first branch, s₁⁽¹⁾, s₂⁽¹⁾, s₃⁽¹⁾, . . . , s_{K-1}⁽¹⁾, s₀⁽¹⁾ for the second branch, and s₁⁽²⁾, s₂⁽²⁾, s₃⁽²⁾, . . . , s_{K-1}⁽²⁾, s₀⁽²⁾ for the third branch of the TBCC codeword.

Part C.

The receiver adds the cyclically shifted received symbols of the previous frame with the received symbols in the current frame. The addition is applied to the two symbols in the same position in the same branch. After the addition, the resulting symbols are r₀⁽⁰⁾+s₁⁽⁰⁾, r₁⁽⁰⁾+s₂⁽⁰⁾, r₂⁽⁰⁾+s₃⁽⁰⁾, . . . , r_{K-2}⁽⁰⁾+s_{K-1}⁽⁰⁾, r_{K-1}⁽⁰⁾+s₀⁽⁰⁾ for the first branch of the TBCC codeword, r₀⁽¹⁾+s₁⁽¹⁾, r₁⁽¹⁾+s₂⁽¹⁾, r₂⁽¹⁾+s₃⁽¹⁾, . . . , r_{K-2}⁽¹⁾+s_{K-1}⁽¹⁾, r_{K-1}⁽¹⁾+s₀⁽¹⁾ for the second branch of the TBCC codeword, and r₀⁽²⁾+s₁⁽²⁾, r₁⁽²⁾+s₂⁽²⁾, r₂⁽²⁾+s₃⁽²⁾, . . . , r_{K-2}⁽²⁾+s_{K-1}⁽²⁾, r_{K-1}⁽²⁾+s₀⁽²⁾ for the third branch of the TBCC codeword.

In block 2505, the receiver decodes the combined received symbols using TBCC. The decoded bits may be denoted as b₀′, b₁′, b₂′, b₃′, . . . , b_{K-1}′.

In block 2506, the receiver attempts CRC detection for message b_{K-1}′, b₀′, b₁′, b₂′, . . . , b_{K-2}′, message b_{K-2}′, b_{K-1}′, b₀′, b₁′, . . . , b_{K-3}′, and message b_{K-3}′, b_{K-2}′, b_{K-1}′, b₀′, . . . , b_{K-4}′. If the CRC checks for b_{K-1}′, b₀′, b₁′, b₂′, . . . , b_{K-2}′, the current frame is the second frame of a 40 ms time interval. If the CRC checks for b_{K-2}′, b_{K-1}′, b₀′, b₁′, . . . , b_{K-3}′, the current frame is the third frame of a 40 ms time interval. If the CRC checks for b_{K-3}′, b_{K-2}′, b_{K-1}′, b₀′, . . . , b_{K-4}′, the current frame is the fourth frame of a 40 ms time interval. If the CRC does not check for any of the three hypotheses, the method proceeds to block 2507.

In block 2507, the receiver attempts soft combining of the received symbols in the current frame with the received symbols in the previous two frames. The receiver may use the following soft combining process:

Part A.

The receiver assigns notations to the received symbols in the frame before the previous frame (after resource de-mapping, Rx MIMO processing, demodulation, descrambling, rate de-matching, and so forth). For example, the received symbols in the frame before the previous frame may be denoted as t₀⁽⁰⁾, t₁⁽⁰⁾, t₂⁽⁰⁾, t₃⁽⁰⁾, . . . , t_{K-1}⁽⁰⁾ for the first branch, t₀⁽¹⁾, t₁⁽¹⁾, t₂⁽¹⁾, t₃⁽¹⁾, . . . , t_{K-1}⁽¹⁾ for the second branch, and t₀⁽²⁾, t₁⁽²⁾, t₂⁽²⁾, t₃⁽²⁾, . . . , t_{K-1}⁽²⁾ for the third branch of the TBCC codeword.

Part B.

The receiver cyclically shift the received symbols in the frame before the previous frame towards the left along the trellis by two (2) bits, resulting in received symbols t₂⁽⁰⁾, t₃⁽⁰⁾, t₄⁽⁰⁾, . . . , t₀⁽⁰⁾, t₁⁽⁰⁾ for the first branch, t₂⁽¹⁾, t₃⁽¹⁾, t₄⁽¹⁾, . . . , t₀⁽¹⁾, t₁⁽¹⁾, for the second branch, and t₂⁽²⁾, t₃⁽²⁾, t₄⁽²⁾, . . . , t₀⁽²⁾, t₁⁽²⁾ for the third branch of the TBCC codeword.

Part C.

The receiver adds the cyclically shifted received symbols of the frame before the previous frame with the received symbols in the current frame and the received symbols in the previous frame. The addition is applied to the three symbols in the same position in the same branch across the three frames.

After the addition, the resulting symbols are r₀⁽⁰⁾+s₁⁽⁰⁾+t₂⁽⁰⁾, r₁⁽⁰⁾+s₂⁽⁰⁾+t₃⁽⁰⁾, r₂⁽⁰⁾+s₃⁽⁰⁾+t₄⁽⁰⁾, . . . , r_{K-2}⁽⁰⁾+s_{K-1}⁽⁰⁾+t₀⁽⁰⁾, r_{K-1}⁽⁰⁾+s₀⁽⁰⁾+t₁⁽⁰⁾ for the first branch, r₀⁽¹⁾+s₁⁽¹⁾+t₂⁽¹⁾, r₁⁽¹⁾+s₂⁽¹⁾+t₃⁽¹⁾, r₂⁽¹⁾+s₃⁽¹⁾+t₄⁽¹⁾, . . . , r_{K-2}⁽¹⁾+s_{K-1}⁽¹⁾+t₀⁽¹⁾, r_{K-1}⁽¹⁾+s₀⁽¹⁾+t₁⁽¹⁾ for the second branch, and r₀⁽²⁾+s₁⁽²⁾+t₂⁽²⁾, r₁⁽²⁾+s₂⁽²⁾+t₃⁽²⁾, r₂⁽²⁾+s₃⁽²⁾+t₄⁽²⁾, . . . , r_{K-2}⁽²⁾+s_{K-1}⁽²⁾+t₀⁽²⁾, r_{K-1}⁽²⁾+s₀⁽²⁾+t₁⁽²⁾ for the third branch of the TBCC codeword.

In step 2508, the receiver decodes the combined received symbols using TBCC. The decoded bits may be denoted as b₀″, b₁″, b₂″, b₃″, . . . , b_{K-1}″.

In block 2509, the receiver attempt CRC detection for message b_{K-2}″, b_{K-1}″, b₀″, b₁″, . . . , b_{K-3}″, and message b_{K-3}″, b_{K-2}″, b_{K-1}″, b₀″, . . . , b_{K-4}″. If the CRC checks for b_{K-2}″, b_{K-1}″, b₀″, b₁″, . . . , b_{K-3}″the current frame is the third frame of a 40 ms time interval. If the CRC checks for b_{K-3}″, b_{K-2}″, b_{K-1}″, b₀″, . . . , b_{K-4}″, the current frame is the fourth frame of a 40 ms time interval. If the CRC does not check for either of the two hypotheses, the method proceeds to block 2510.

In block 2510, the receiver combines the received symbols in the current frame with the received symbols in the previous three (3) frames. The receiver may use a three-part process similar to the process described in block 2504 and block 2507.

In step 2511, the receiver decodes the combined received symbols using TBCC. The decoded bits may be denoted as b₀′″, b₁′″, b₂′″, b₃′″, . . . , b_{K-1}′″. This block is similar to block 2505 and 2508.

In step 2512, the receiver attempts CRC detection for the message b_{K-3}′″, b_{K-2}′″, b_{K-1}′″, b₀′″, . . . , b_{K-4}′″. If the CRC checks, the current frame is the fourth frame of a 40 ms time interval. If the CRC does not check, the receiver is not able to acquire PBCH in this frame. The receiver may save the received symbols in this frame and wait for a new PBCH transmission in the next frame.

Although FIG. 25 illustrates one example of a method 2500 for detecting frame timing, various changes may be made to FIG. 25. For example, although the method 2500 is described where the number of cyclic shifts in the first frame of a 40 ms interval is zero (0), the number of cyclic shifts in the second frame of a 40 ms interval is one (1), the number of cyclic shifts in the third frame of a 40 ms interval is two (2), and the number of cyclic shifts in the fourth frame of a 40 ms interval is three (3), different mappings between the number of cyclic shifts and the frame timing may be used.

As another example, in blocks 2503, 2506, and 2509, the receiver may only attempt CRC detection for one hypothesis of cyclic shift. The receiver may only attempt CRC detection for cyclic shift 0 (corresponding to the hypothesis that the current frame is the first frame of a 40 ms time interval) in block 2503. The receiver may only attempt CRC detection for cyclic shift 1 (corresponding to the hypothesis that the current frame is the second frame of a 40 ms time interval) in block 2506. The receiver may only attempt CRC detection for cyclic shift 2 (corresponding to the hypothesis that the current frame is the third frame of a 40 ms time interval) in block 2509.

As yet another example, the soft combining with previous frames can be optimized by storing some of the values that have been calculated in block 2504 for use in block 2507, and by storing some of the values that have been calculated in block 2507 for use in block 2510. The soft combining with previous frames in blocks 2504, 2507, and 2510 can be further optimized by storing some of the values that have been calculated in previous frames to further reduce computational complexity. However, these techniques for computational complexity reduction may come at a price of increased memory.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. For use in a multi-carrier wireless communication network, a transmitter configured to encode a control channel message, the transmitter comprising:
a CRC (cyclic redundancy check) encoder configured to encode the control channel message using a cyclic redundancy check; and
a CIF (carrier indication field) encoder coupled to the CRC encoder and configured to encode a carrier indication value in the control channel message, the carrier indication value configured to indicate an intended component carrier of the control channel message.

2. The transmitter of claim 1, wherein the CIF encoder is configured to encode the carrier indication value by cyclically shifting a plurality of bits in the control channel message a predetermined number of times, the predetermined number corresponding to the intended component carrier of the control channel message.

3. The transmitter of claim 1, further comprising:
a tail-biting convolutional code (TBCC) encoder configured to encode the control channel message using a TBCC code.

4. The transmitter of claim 1, wherein the CRC encoder encodes the control channel message and then the CIF encoder encodes the carrier indication value in the CRC-encoded control channel message.

5. The transmitter of claim 1, wherein the CIF encoder encodes the carrier indication value in the control channel message before the CRC encoder encodes the control channel message.

6. The transmitter of claim 1, wherein the control channel message is one of a Downlink Control Information (DCI) message and an Uplink Control Information (UCI) message.

7. For use in a multi-carrier wireless communication network, a method for a transmitter to encode a control channel message, the method comprising:
encoding the control channel message using a cyclic redundancy check (CRC); and
encoding a carrier indication value in the control channel message, the carrier indication value configured to indicate an intended component carrier of the control channel message.

8. The method of claim 7, wherein encoding the carrier indication value in the control channel message comprises cyclically shifting a plurality of bits in the control channel message a predetermined number of times, the predetermined number corresponding to the intended component carrier of the control channel message.

9. The method of claim 7, further comprising:
encoding the control channel message using a tail-biting convolutional code (TBCC).

10. The method of claim 7, wherein the encoding of the control channel message using the CRC is performed before the encoding of the carrier indication value in the control channel message.

11. The method of claim 7, wherein the encoding of the carrier indication value in the control channel message is performed before the encoding of the control channel message using the CRC.

12. For use in a multi-carrier wireless communication network, a method for a transmitter to interleave a control channel message, the method comprising:
adding a cyclic redundancy check (CRC) to the control channel message;
encoding the control channel message using a tail-biting convolutional code (TBCC); and
interleaving the control channel message using an interleaving pattern, the interleaving pattern configured to indicate an intended component carrier of the control channel message.

13. The method of claim 12, further comprising:
rate matching a number of bits to be transmitted in the control channel message based on an amount of resources allocated for the transmission.

14. For use in a multi-carrier wireless communication network, a transmitter configured to interleave a control channel message, the transmitter comprising:
a cyclic redundancy check (CRC) encoder configured to add a CRC to the control channel message;
a tail-biting convolutional code (TBCC) encoder configured to encode the control channel message using a TBCC code; and
an interleaver configured to interleave the control channel message using an interleaving pattern, the interleaving pattern configured to indicate an intended component carrier of the control channel message.

15. The transmitter of claim 14, further comprising:
a rate matcher configured to rate match a number of bits to be transmitted in the control channel message based on an amount of resources allocated for the transmission.

16. For use in a multi-carrier wireless communication network, a method for a transmitter to encode a cyclic redundancy check, the method comprising:
calculating a cyclic redundancy check (CRC) for a first control channel message using a first CRC generator polynomial, the first CRC generator polynomial associated with a first component carrier;
calculating a CRC for a second control channel message using a second CRC generator polynomial, the second CRC generator polynomial associated with a second component carrier; and
encoding the first and second control channel messages using a tail-biting convolutional code (TBCC).

17. The method of claim 16, wherein the first CRC generator polynomial and the second CRC generator polynomial do not have the same length.

18. The method of claim 16, further comprising:
scrambling the CRC for the first control channel message using a first scrambling sequence; and
scrambling the CRC for the second control channel message using a second scrambling sequence.

19. For use in a multi-carrier wireless communication network, a transmitter configured to encode a cyclic redundancy check, the transmitter comprising:
a CRC (cyclic redundancy check) encoder configured to:
calculate a (CRC) for a first control channel message using a first CRC generator polynomial, the first CRC generator polynomial associated with a first component carrier; and
calculate a CRC for a second control channel message using a second CRC generator polynomial, the second CRC generator polynomial associated with a second component carrier; and
a tail-biting convolutional code (TBCC) encoder configured to encode the first and second control channel messages using a TBCC code.

20. The transmitter of claim 19, wherein the first CRC generator polynomial and the second CRC generator polynomial do not have the same length.

21. The transmitter of claim 19, further comprising:
a scrambler block configured to:
scramble the CRC for the first control channel message using a first scrambling sequence; and
scramble the CRC for the second control channel message using a second scrambling sequence.

22. For use in a multi-carrier wireless communication network, a method for a transmitter to change a resource mapping in a control channel message, the method comprising:
adding a cyclic redundancy check (CRC) to the control channel message;
encoding the control channel message using a tail-biting convolutional code (TBCC); and
changing a resource mapping in the control channel message from a modulation symbol to a resource element using a mapping pattern, the mapping pattern selected based on an intended component carrier of the control channel message.

23. The method of claim 22, wherein the mapping pattern is selected from a plurality of available mapping patterns, each available mapping pattern associated with the intended component carrier and a subcarrier index of the resource element.

24. For use in a multi-carrier wireless communication network, a transmitter configured to change a resource mapping in a control channel message, the transmitter comprising:
a cyclic redundancy check (CRC) encoder configured to add a CRC to the control channel message;
a tail-biting convolutional code (TBCC) encoder configured to encode the control channel message using a TBCC code; and
a resource mapping block configured to change a resource mapping in the control channel message from a modulation symbol to a resource element using a mapping pattern, the mapping pattern selected based on an intended component carrier of the control channel message.

25. The transmitter of claim 24, wherein the mapping pattern is selected from a plurality of available mapping patterns, each available mapping pattern associated with the intended component carrier and a subcarrier index of the resource element.

26. For use in a multi-carrier wireless communication network, a method for a transmitter to change rate matching of a control channel message, the method comprising:
adding a cyclic redundancy check (CRC) to the control channel message;
encoding the control channel message using a tail-biting convolutional code (TBCC); and
cyclically shifting a start position of a circular buffer that receives the TBCC-encoded control channel message, the cyclically shifting depending on an intended component carrier of the control channel message.

27. The method of claim 26, wherein the control channel message is one of a Downlink Control Information (DCI) message and an Uplink Control Information (UCI) message.

28. For use in a multi-carrier wireless communication network, a transmitter configured to change rate matching of a control channel message, the transmitter comprising:
a cyclic redundancy check (CRC) encoder configured to add a CRC to the control channel message;
a tail-biting convolutional code (TBCC) encoder configured to encode the control channel message using a TBCC code; and
a rate matcher block configured to cyclically shift a start position of a circular buffer that receives the TBCC-encoded control channel message, the cyclically shifting depending on an intended component carrier of the control channel message.

29. The transmitter of claim 28, wherein the control channel message is one of a Downlink Control Information (DCI) message and an Uplink Control Information (UCI) message.

30. For use in a wireless network, a transmitter configured to encode timing information, the transmitter comprising:
a CRC (cyclic redundancy check) encoder configured to encode a physical broadcast channel (PBCH) message using a cyclic redundancy check;
a cyclic shift block configured to encode frame timing information in the PBCH message; and
a tail-biting convolutional code (TBCC) encoder configured to encode the PBCH message using a TBCC code.

31. The transmitter of claim 30, wherein the cyclic shift block is configured to encode the frame timing information in the PBCH message by cyclically shifting a plurality of bits in the PBCH message a predetermined number of times, the predetermined number corresponding to a value of the frame timing information.

32. The transmitter of claim 30, wherein the frame timing information comprises a final two bits of a system frame number (SFN) of a frame.

33. The transmitter of claim 30, wherein the cyclic shift block encodes the frame timing information in the PBCH message and then the TBCC encoder encodes the PBCH message using the TBCC code.

34. The transmitter of claim 30, wherein the TBCC encoder encodes the PBCH message using the TBCC code before the cyclic shift block encodes the frame timing information in the PBCH message.

35. The transmitter of claim 30, wherein the frame timing information is encoded in the PBCH message such that a receiver is capable of detecting the frame timing information either after or before TBCC-decoding the PBCH message.

36. For use in a wireless network, a method of encoding timing information at a transmitter, the method comprising:
encoding a physical broadcast channel (PBCH) message using a cyclic redundancy check (CRC);
encoding frame timing information in the PBCH message; and
encoding the PBCH message using a tail-biting convolutional code (TBCC).

37. The method of claim 36, wherein encoding the frame timing information in the PBCH message comprises cyclically shifting a plurality of bits in the PBCH message a predetermined number of times, the predetermined number corresponding to a value of the frame timing information.

38. The method of claim 36, wherein the frame timing information comprises a final two bits of a system frame number (SFN) of a frame.

39. The method of claim 36, wherein the encoding of the frame timing information in the PBCH message is performed before the encoding of the PBCH message using the TBCC code.

40. The method of claim 36, wherein the encoding of the PBCH message using the TBCC code is performed before the encoding of the frame timing information in the PBCH message.

41. The method of claim 36, wherein the frame timing information is encoded in the PBCH message such that a receiver is capable of detecting the frame timing information either after or before TBCC-decoding the PBCH message.

42. For use in a wireless communication network, a method for a receiver to detect frame timing, the method comprising:
receiving code symbols of a physical broadcast channel (PBCH) in a message;
decoding the received code symbols using a tail biting convolutional code (TBCC);
examining the TBCC-decoded symbols for a cyclic redundancy check (CRC);
cyclically shifting the TBCC-decoded symbols;
repeating the examining and cyclically shifting steps until a CRC check is established; and
determining a current frame number based on a number of times the TBCC-decoded symbols are cyclically shifted.

43. The method of claim 42, further comprising:
soft combining the received code symbols of a current frame with the received code symbols of a previous frame.
